(19) United States
(12) Patent Application Publication
(10) Pub. No.: US 2026/0270933 A1
(43) Pub. Date: Sep. 10, 2026

(54) SIDELINK POSITIONING REFERENCE SIGNAL (SL-PRS) TYPE CHANGE REQUEST IN A SIDELINK POSITIONING GROUP (SPG)

(71) Applicant: SHARP KABUSHIKI KAISHA, Sakai City, Osaka (JP)

(72) Inventors: Kenneth James Park, Vancouver, WA (US); TOMOKI YOSHIMURA, Sakai City, Osaka (JP); ZHANPING YIN, Vancouver, WA (US)

(21) Appl. No.: 19/114,527

(22) PCT Filed: Sep. 6, 2023
(86) PCT No.: PCT/JP2023/032494

§ 371 Date: Mar. 24, 2025

Related U.S. Application Data
(60) Provisional application No. 63/410,197, filed on Sep. 26, 2022.

(51) Int. Cl. H04W 64/00; H04W 72/25

(52) U.S. Cl. CPC H04W 64/00; H04W 72/25

(57) ABSTRACT

A terminal device to request a change in a type of Sidelink Positioning Reference Signal (SL-PRS) for a Sidelink Positioning Group (SPG) in a New Radio (NR) system includes: one or more non-transitory computer-readable media; and at least one processor configured to execute a set of computer-executable instructions to cause the terminal device to perform operations including: receiving, as a target terminal device associated with the SPG, from an anchor terminal device of the SPG, a first type of SL-PRS for the SPG; transmitting, to the anchor terminal device, a first message including a request to change to a second type of SL-PRS for the SPG, the second type of SL-PRS being different from the first type of SL-PRS; and receiving, from the anchor terminal device, in response to the anchor terminal device determining that the second type of SL-PRS is supported in the SPG, the second type of SL-PRS for the SPG.

### CROSS REFERENCE

This Nonprovisional application claims priority under 35 U.S.C. § 119 on provisional Application No. 63/410,197 on Sep. 26, 2022, the entire contents of which are hereby incorporated by reference.

### TECHNICAL FIELD

The present disclosure generally relates to wireless communications and, more specifically, to a Sidelink Position Reference Signal (SL-PRS) type change request by a device associated with a Sidelink Positioning Group (SPG) in a wireless network (e.g., a fifth generation (5G) (e.g., New Radio (NR)) network).

### BACKGROUND ART

The 3rd Generation Partnership Project (3GPP) (e.g., as indicated in Release 17 (Rel-17) of 3GPP) has conducted studies relating to “NR positioning enhancements” and “scenarios and requirements of in-coverage, partial coverage, and out-of-coverage NR positioning use cases.”

The study regarding NR positioning enhancements investigated higher accuracy and lower latency location determination, particularly in view of high integrity and reliability requirements resulting from new applications and industry verticals for 5G. Some of the enhancements identified during this work have been specified in the 3GPP Rel-17 Work Item (WI) on “NR Positioning Enhancements,” but several opportunities for enhancement remain that are yet to be studied and/or released in any of the 3GPP specifications.

The study relating to scenarios and requirements of in-coverage, partial coverage, and out-of-coverage NR positioning use cases focuses on vehicle-to-everything (V2X) features and public safety use cases (e.g., where the outcome has been captured in Technical Report (TR) 38.845). Additionally, the 3GPP Technical Specification Group (TSG) Service and System Aspects (SA) Working Group 1 (WG1) (more commonly known as “SA1”) has developed requirements in Technical Specification (TS) 22.261 for “ranging-based services” and has developed positioning accuracy requirements in TS 22.104 for Industrial Internet of Things (IIoT) use cases (e.g., in out-of-coverage scenarios). However, there remains a need for 3GPP to study and develop sidelink (SL) positioning solutions that can support the use cases, scenarios, and requirements identified during such activities.

Regarding higher accuracy, promising techniques identified in earlier studies may be considered in the 3GPP Rel-18 study (e.g., the “Study on expanded and improved NR positioning (Acronym: FS_NR_pos_enh2), as discussed in 3GPP Radio Access Network (RAN) Work Item Description (WID) RP-213588). One aspect of the study looks to take advantage of the rich 5G spectrum to increase the bandwidth for the transmission and reception of Positioning Reference Signals (PRSs). That is, enhancements to positioning techniques may be achieved by taking advantage of the wider bandwidths provided by NR, for example, by way of Frequency Range 1 (FR1) (e.g., below 7.125 gigahertz (GHz)) and FR2 (e.g., the millimeter wave range of 24.25 to 71.2 GHz), such that different PRSs may be allocated to resources that may be transmitted and/or received by both a base station (e.g., Next Generation NodeB (gNB)) and a user equipment (UE).

In addition, the 3GPP TSG Radio Access Network (RAN) WG1 (more commonly known as “RAN1”) has begun a Rel-18 study on expanded and improved NR positioning, which derives many of its requirements from the above SA1 requirements. This RAN1 study covers three main areas: (1) sidelink positioning, (2) improved positioning accuracy, integrity, and power efficiency, and (3) positioning for “RedCap” (reduced capacity) UEs.

As described in greater detail below, in employing such positioning enhancements, further innovations to facilitate PRSs as they relate to sidelink communications are desirable.

### SUMMARY OF INVENTION

In one example, a terminal device for requesting a change in a type of Sidelink Positioning Reference Signal (SL-PRS) for a Sidelink Positioning Group (SPG) in a New Radio (NR) system, the terminal device comprises: one or more non-transitory computer-readable media storing a set of computer-executable instructions; and at least one processor coupled to the one or more non-transitory computer-readable media and configured to execute the set of computer-executable instructions to cause the terminal device to perform operations comprising: receiving, as a target terminal device associated with the SPG, from an anchor terminal device of the SPG, a first type of SL-PRS for the SPG; transmitting, to the anchor terminal device, a first message comprising a request to change to a second type of SL-PRS for the SPG, the second type of SL-PRS being different from the first type of SL-PRS; and receiving, from the anchor terminal device, in response to the anchor terminal device determining that the second type of SL-PRS is supported in the SPG, the second type of SL-PRS for the SPG.

In one example, a terminal device for receiving a request to change a type of Sidelink Positioning Reference Signal (SL-PRS) for a Sidelink Positioning Group (SPG) administered by the terminal device in a New Radio (NR) system, the terminal device comprises: one or more non-transitory computer-readable media storing a set of computer-executable instructions; and at least one processor coupled to the one or more non-transitory computer-readable media and configured to execute the set of computer-executable instructions to cause the terminal device to perform operations comprising: transmitting, to a target terminal device associated with the SPG, a first type of SL-PRS for the SPG; receiving, from the target terminal device, a first message comprising a request to change to a second type of SL-PRS for the SPG, the second type of SL-PRS being different from the first type of SL-PRS; determining whether the second type of SL-PRS is supported in the SPG; and transmitting, to the target terminal device, after determining that the second type of SL-PRS is supported in the SPG, the second type of SL-PRS for the SPG.

### BRIEF DESCRIPTION OF DRAWINGS

Implementations of the present technology will now be described, by way of example only, with reference to the attached figures.

FIG. 1A is diagram illustrating a transmission pattern of a PRS and a transmission pattern of a Sounding Reference Signal (SRS), respectively, according to an example implementation of the present disclosure.

FIG. 1B is diagram illustrating a transmission pattern of a PRS and a transmission pattern of a Sounding Reference Signal (SRS), respectively, according to an example implementation of the present disclosure.

FIG. 2 is a flowchart illustrating a method performed by a UE and an anchor UE (AUE) administering a Sidelink Positioning Group (SPG) to authorize the UE to join the SPG, according to an example implementation of the present disclosure.

FIG. 3 is a communication diagram illustrating communications occurring between the UE and the AUE during the method of FIG. 2, according to an example implementation of the present disclosure.

FIG. 4 is a flowchart illustrating a method performed by a UE to join an SPG administered by an AUE, according to an example implementation of the present disclosure.

FIG. 5 is a flowchart illustrating a method performed by an AUE to authorize another UE to join an SPG administered by the AUE, according to an example implementation of the present disclosure.

FIG. 6 is a flowchart illustrating a method performed by a Target UE (TUE) and an AUE of an SPG to change a type of SL-PRS used by the SPG at the request of the TUE, according to an example implementation of the present disclosure.

FIG. 7 is a communication diagram illustrating communications occurring between the TUE and the AUE during the method of FIG. 6, when the change of the type of SL-PRS is successful, according to an example implementation of the present disclosure.

FIG. 8 is a communication diagram illustrating communications occurring between the TUE and the AUE during the method of FIG. 6, when the change of the type of SL-PRS is unsuccessful, according to an example implementation of the present disclosure.

FIG. 9 is a flowchart illustrating a method performed by a TUE belonging to an SPG administered by an AUE to request the AUE to change a type of SL-PRS being used by the SPG, according to an example implementation of the present disclosure.

FIG. 10 is a flowchart illustrating a method performed by an AUE to change a type of SL-PRS used by an SPG administered by the AUE at the request of a TUE, according to an example implementation of the present disclosure.

FIG. 11 is a block diagram illustrating a node for wireless communication, according to an example implementation of the present application.

### DESCRIPTION OF EMBODIMENTS

The 3GPP is a collaboration agreement that aims to define globally applicable technical specifications and technical reports for third and fourth generation wireless communication systems. The 3GPP may also define specifications for next generation mobile networks, systems, and devices.

3GPP Long-Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A), and other standards (e.g., 3GPP Releases 8, 9, 10, 11, 12, 13, 14, 15, and so on) including New Radio (NR), which is also known as 5G. However, the scope of the present disclosure should not be limited in this regard. At least some aspects of the systems and methods disclosed herein may be utilized in other types of wireless communication systems.

A wireless communication device may be an electronic device used to communicate voice and/or data to a base station (BS), which in turn may communicate with a network of devices (e.g., a public switched telephone network (PSTN), the Internet, etc.). In describing systems and methods herein, a wireless communication device may alternatively be referred to as a mobile station, a UE, an access terminal, a subscriber station, a mobile terminal, a remote station, a user terminal, a terminal, a subscriber unit, a mobile device, etc. Examples of wireless communication devices may include cellular phones, smart phones, personal digital assistants (PDAs), laptop computers, netbooks, e-readers, wireless modems, etc.

In the 3GPP specifications, a wireless communication device may typically be referred to as a UE. However, as the scope of the present disclosure should not be limited to the 3GPP standards, the terms “UE” and “wireless communication device” may be used interchangeably herein to mean the more general term “wireless communication device.” A UE may also be more generally referred to as a terminal device.

In the 3GPP specifications, a BS is typically referred to as a NodeB, an evolved NodeB (eNB), a home enhanced or evolved NodeB (HeNB), a Next Generation NodeB (gNB), or some other similar terminology. As the scope of the disclosure should not be limited to 3GPP standards, the terms “base station,” “NodeB,” “eNB,” “HeNB,” and “gNB” may be used interchangeably herein to mean the more general term “base station.” Furthermore, the term “base station” or “BS” may be used to denote an access point. An access point may be an electronic device that provides access to a network (e.g., a Local Area Network (LAN), the Internet, etc.) for wireless communication devices. The term “communication device” may be used to denote both a wireless communication device and/or a base station. An eNB and/or gNB may also be more generally referred to as a base station device.

It should be noted that, as used herein, a “cell” may be any communication channel that is specified by standardization or regulatory bodies to be used for International Mobile Telecommunications-Advanced (IMT-Advanced), and all of IMT-Advanced, or a subset thereof, may be adopted by 3GPP as licensed bands (e.g., frequency bands) to be used for communication between an eNB and a UE. It should also be noted that in the E-UTRA and E-UTRAN overall description, as used herein, a “cell” may be defined as a “combination of downlink and optionally uplink resources.” The linking between the carrier frequency of the downlink resources and the carrier frequency of the uplink resources may be indicated in the system information transmitted on the downlink resources.

“Configured cells” are those cells of which the UE is aware and is allowed by an eNB and/or gNB to transmit or receive information. “Configured cell(s)” may be serving cell(s). The UE may receive system information and perform the required measurements on all configured cells. “Configured cell(s)” for a radio connection may include a primary cell and/or no, one, or more secondary cell(s).

“Activated cells” are those configured cells on which the UE is transmitting and receiving. That is, activated cells are those cells for which the UE monitors the physical downlink control channel (PDCCH) and, in the case of a downlink transmission, those cells for which the UE decodes a physical downlink shared channel (PDSCH). “Deactivated cells” are those configured cells for which the UE is not monitoring the transmission of PDCCH. It should be noted that a “cell” may be described in terms of differing dimensions. For example, a “cell” may have temporal, spatial (e.g., geographical), and frequency characteristics.

The 5G communication systems, dubbed NR technologies by the 3GPP, envision the use of time/frequency/space resources to allow for services, such as Enhanced Mobile Broadband (eMBB) transmission, Ultra-Reliable Low-Latency Communications (URLLC) transmission, and massive Machine Type Communication (mMTC) transmission. Also, in NR, single-beam and/or multi-beam operations are considered for downlink and/or uplink transmissions.

Various examples of the systems and methods disclosed herein are now described with reference to the figures, where like reference numbers may indicate functionally similar elements. The systems and methods as generally described and illustrated in the figures herein could be arranged and designed in a wide variety of different implementations. Therefore, the detailed description of the present disclosure as illustrated in the figures is not intended to limit the scope of the present disclosure but is merely representative of the systems and methods.

A basic discussion of some aspects of NR communication technology is provided below, followed by a more specific discussion relating to embodiments described in the present disclosure.

### NR Frame Structure

The 5G NR Frame structure is described in the NR 3GPP standards (e.g., Technical Specification (TS) 38.211). The 5G NR frame structure includes subframes, slots, and symbol configurations. As described above, the 5G NR Supports two frequency ranges: FR1 (which is under 7.125 gigahertz (GHz)) and FR2 (also known as millimeter wave range, which is between 24.25 GHz to 71.2 GHz). NR uses flexible subcarrier spacing derived from basic 15 kilohertz (kHz) subcarrier spacing that is also used in the LTE. A frame may have a duration of 10 milliseconds (ms) which may include 10 subframes each having 1 ms duration, which is similar to the LTE networks. Each subframe may have 24 slots (μ being a member of the set of [0 . . . 4]). Each slot may typically include 14 orthogonal frequency division multiplexing (OFDM) symbols. The number of symbols, however, may depend upon the start and length indicator value (SLIV). The radio frames of 10 ms may be transmitted continuously one after the other as per Time Division Duplex (TDD) or Frequency Division Duplex (FDD) topology. A subframe may be of a fixed duration (e.g., 1 ms) whereas a slot's length may vary based on a subcarrier spacing (SCS) and the number of slots per subframe. A slot is 1 ms for 15 kHz, 500 us for 30 kHz, and so on. The subcarrier spacing of 15 kHz may occupy one slot per subframe, whereas the subcarrier spacing of 30 kHz may occupy two slots per subframe, and so on. Each slot may occupy either 14 OFDM symbols or 12 OFDM symbols, depending on the normal cyclic prefix (CP) or extended CP, respectively.

It should be noted that even though for the remainder of this disclosure, a 14-symbol configuration that is based on a normal CP is discussed, a 12-symbol configuration that is based on an extended CP may not be precluded from the solution space.

In 5G, a resource grid (RG) is the grouping of uplink (UL) or downlink (DL) resources at the physical layer of a given numerology (described below). The time domain is usually expressed as symbols of a slot, and as slots of a subframe, and the frequency domain is typically expressed as the available resource block (RB) (also described below) within the transmission bandwidth.

In 5G, a resource element (RE) is the smallest physical resource in NR which may include one subcarrier during one OFDM symbol. Also, in 5G, one NR Resource Block (RB) may contain 12 subcarriers in the frequency domain, irrespective of the numerology, and is defined only in the frequency domain (e.g., the bandwidth may not be fixed and may be dependent upon the configured subcarrier spacing). Additionally, in 5G, Physical Resource Blocks (PRBs) are the RBs that are used for actual/physical transmission/reception.

### NR Numerology

Numerology is a term used in the 3GPP specification to describe the different subcarrier spacing types, as there are several different types of subcarrier spacing as summarized in the following Table 1 (which is similar to the Table 4.2-1 in TS 38.211) that defines the supported transmission numerologies.

TABLE 1

| μ | Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

It should be noted that for the remainder of this disclosure, the terms numerology and subcarrier spacing (SCS) may be used interchangeably. It should also be noted that the term “SCS configuration factor n” may be used to refer to a subcarrier spacing type, where n may belong to the set [0,1,2,3,4], as noted in the table above and is referred to as μ

### Physical Layer Design for NR V2X Sidelink

The physical layer structure for the NR V2X sidelink is based on the Rel-15 NR interface (Uu) design. In addition, the physical layer procedures for the NR V2X sidelink (SL) may reuse some of the concepts of Rel-14 LTE V2X, with the introduction of additional procedures for providing physical layer support for unicast and groupcast transmissions.

### NR V2X Physical Channels and Signals

A Physical Sidelink Control Channel (PSCCH) is sent within the first SL symbols of the first subchannel occupied by an associated Physical Sidelink Shared Channel (PSSCH), described below. The PSCCH carries the first-stage Sidelink Control Information (SCI) (discussed more fully below), which indicates at least: (1) resource allocation, Modulation and Coding Scheme (MCS), and priority of the associated PSSCH; (2) resource reservation period; (3) time pattern and number of ports for the PSSCH Demodulation Reference Signal (DMRS); and/or (4) size and format of second-stage SCI.

A Physical Sidelink Shared Channel (PSSCH) is sent in one or multiple subchannels in a slot within a resource pool. The PSSCH carries a Transport Block (TB) (discussed in greater detail below) and the second-stage SCI, which indicates: (1) a Hybrid Automatic Repeat Request (HARQ) process ID, new data indicator (NDI), and redundancy version (RV); (2) Source ID and Destination ID; (3) HARQ enabled/disabled indicator; (4) transmission type and Channel State Information (CSI) request (SCI format 2-A); and/or (5) transmission (TX) UE's zone ID and required communication range (SCI format 2-B).

A Physical Sidelink Broadcast Channel (PSBCH) is sent periodically with a SL Primary Synchronization Signal (S-PSS) and a SL Secondary Synchronization Signal (S-SSS) in an SL Synchronization Signal Block (S-SSB), not in slots of a resource pool. The PSBCH may carry (1) a TDD configuration; (2) a direct frame number; (3) a slot index; and/or (4) an In-network/Global Navigation Satellite System (GNSS) coverage indicator.

A Physical Sidelink Feedback Channel (PSFCH) is sent periodically in a symbol near the end of a PSCCH/PSSCH slot. The PSFCH is transmitted in response to a PSSCH reception and carries the HARQ feedback (1) for unicast (Acknowledgement/Negative-Acknowledgement (ACK/NACK) feedback) or (2) for groupcast (NACK-only feedback (option 1) or ACK/NACK feedback (option 2)).

Transport Blocks (TBs) are the objects into which data is organized and that are carried in the PSSCH. Each TB is associated with an SCI. The SCI indicates the resources used by the PSSCH that carries the associated TB, as well as further information required for decoding the TB. A TB may occupy one or several subchannels depending on the size of the packet, the number of RBs per subchannel, and the utilized MCS. TBs may be transmitted using Quadrature Phase Shift Keying (QPSK), 16 Quadrature Amplitude Modulation (16QAM), or 64QAM modulations and turbo coding.

Regarding the SCI, each TB has an associated SCI message that is carried in the PSCCH. An SCI may include information such as (1) an indication of the RBs occupied by the associated TB; (2) the MCS used for the TB; (3) the priority of the message that is being transmitted; (4) an indication of whether it is a first transmission or a blind retransmission of the TB; and/or (5) the resource reservation interval. The SCI may include critical information for the correct reception of the TB. A TB may not be decoded properly if the associated SCI is not received correctly. A TB and its associated SCI may be transmitted in the same subframe. The TB and its associated SCI may be transmitted in adjacent subchannels. Alternatively, RBs can be divided into two pools, in which one pool is dedicated to transmitting SCIs and the other pool is dedicated to transmitting TBs.

The SCI in NR V2X may be transmitted in two stages. The first stage SCI in NR V2X may be carried on the PSCCH, while the second stage SCI may be carried on the corresponding PSSCH. Splitting the SCI in two stages (e.g., the first stage SCI and the second stage SCI) may allow other UEs which are not receiving (RX) UEs of a transmission to decode only the first stage SCI.

Further, the PSCCH may carry the first stage SCI that contains control information associated with a PSSCH and the second stage SCI. The first stage SCI may indicate the frequency resources (e.g., subchannels) of the PSSCH carrying the current transmission of a TB, as well as the resource reservation for up to two further retransmissions of the TB.

The PSSCH may carry the second stage SCI and the data payload including a TB. The second stage SCI may carry information used for decoding the PSSCH and for supporting HARQ feedback and CSI reporting. The second stage SCI may indicate the Layer 1 source ID and destination ID of a transmission that represent identifiers (in the physical layer) of the TX UE and intended recipients (RX UEs) of the TB. The Layer 1 source ID may allow an RX UE to know the identity of the TX UE, which may be used for determining the PSFCH for HARQ feedback.

After decoding the first stage SCI in the PSCCH, an RX UE may have the necessary information to decode the second stage SCI carried in the PSSCH. Thus, no blind decoding of the second stage SCI is needed.

The first stage SCI, having a fixed size and carried in the PSCCH, provides that the SCI has a known location within a subchannel. When the first stage SCI is decoded, it may indicate the resources of the second stage SCI carried in the PSSCH, and thus the second stage SCI may not be blind-decoded, and the second stage SCI may have a varying payload size.

### Positioning Reference Signals

To enable more accurate positioning measurements than LTE, new dedicated reference signals are added to the NR Rel-16 specifications with a high Resource Element (RE) density and with the correlation properties that are better than existing reference signals due to the diagonal or staggered reference signal patterns. In the downlink, the new signal is known as the “NR Positioning Reference Signal” (which may also be known as NR PRS, or only PRS) and in the uplink, the new signal is known as the “Sounding Reference Signal” (SRS) for positioning (e.g., determining the location of a UE).

It should be noted that in releases prior to the 3GPP Rel-16, an SRS may also be defined and used by the base station to estimate the quality of the uplink channel for the large bandwidths outside the assigned span to a specific UE. However, the prior release's SRS may have limitations on its density of use in the time domain that do not apply to the Rel-16 SRS for positioning. As such, the SRS for positioning and the SRS for channel quality estimation are configured separately and with different properties specific to their usage. Thus, for the remainder of this disclosure, any reference to an SRS may apply to the SRS for positioning.

### Downlink PRS Signal

In downlink (DL) transmissions, a dedicated Positioning Reference Signal (PRS) for positioning purposes (e.g., determining the location of a UE) is specified in 3GPP Rel-16. The PRS may include a pseudo-random sequence that is modulated by QPSK. The pseudo-random sequence may include a Gold sequence of length 31. The PRS is described in more detail in the 5G standard in TS 38.211. The generation of the PRS may include two steps: generation of PRS sequences based on Gold sequences and the PRS mapping.

A potential benefit of using a pseudo-random sequence for the PRS is its low sensitivity to timing and frequency offset error degradation, which may be a common condition when considering V2X scenarios with synchronization error and high device mobility.

### Uplink SRS Signal

In uplink (UL) transmissions, there is no dedicated pilot for positioning, so the Sounding Reference Signal (SRS) may be selected for this purpose. In 5G NR, the SRS generation is implemented according to the 3GPP TS 38.211. The uplink 5G NR sounding reference signal (NR-SRS) sent by the UE may be an OFDM-modulated Zadoff-Chu sequence that is feasible for time delay estimation. Similar to the generation of the PRS, the generation of the SRS may also include two steps: Zadoff-Chu sequence generation and the SRS mapping.

A potential benefit of using a Zadoff-Chu sequence for the PRS is that it may provide for better Peak-to-Average Power Ratio (PAPR) over the signal's transmission bandwidth compared to a pseudo-random sequence. However, one of the possible drawbacks of a Zadoff-Chu sequence is that it may be more sensitive to timing and frequency offset degradation, which may have a direct negative impact on positioning measurement. Such timing and frequency offset degradation may be more pronounced when considering V2X scenarios that address synchronization error and high device mobility.

### Default Sidelink Positioning Reference Signal

For Rel-18 sidelink communications, it is expected that a “new dedicated positioning reference signal” will be defined for the PC5 interface. The purpose of the new dedicated positioning reference signal may be to assist the NR V2X-enabled device with respect to utilizing new Rel-18 sidelink positioning processes. For the purposes of this disclosure, this new dedicated Sidelink Position Reference Signal is referred to as SL-PRS.

However, support for SL-PRS may be optional; thus, not all NR-capable devices may be required to support it. While support for SL-PRS may be optional for some devices (e.g., low-cost IoT devices), support for SL-PRS may be mandatory for the NR gNB and other network (NW) components of the system. Thus, a default SL-PRS configuration may be known to the gNB and other NW components of the system, and the default SL-PRS configuration may also be known to the devices that optimally support SL-PRS.

A default SL-PRS may be defined to use a configuration that includes a signal encoding generator such as in Example A or Example B below:

Example A: A pseudo-random sequence that is modulated by QPSK. The pseudo-random sequence may use a Gold sequence of length 31, as specified in the 5G standard in TS 38.211.

Example B: An OFDM-modulated Zadoff-Chu sequence that is feasible for time delay estimation. The Zadoff-Chu sequence generation may be implemented as specified in the 5G standard in TS 38.211.

A default SL-PRS configuration may also be referred to herein as a “type of SL-PRS”.

### Optional Sidelink Positioning Reference Signal

For Rel-18 sidelink communications, it is also expected that, in addition to the default SL-PRS configuration, one or more optional SL-PRS configurations may be defined. As NR-capable devices may not be required to support optional SL-PRS configurations, the optional SL-PRS configurations that are supported by NR-capable devices that support SL-PRS may not be known a priori to the gNB and other NW components of the system. Thus, additional communications between the NR-capable devices that support SL-PRS and the NR system may be needed to exchange information regarding the optional SL-PRS configurations that can be supported by the NR-capable devices that support SL-PRS.

An optional SL-PRS may be defined to use a configuration that includes a signal encoding generator such as in Example A or Example B below:

Example A: A pseudo-random sequence that is modulated by QPSK. The pseudo-random sequence may use a Gold sequence of length 31, as specified in the 5G standard in TS 38.211.

Example B: An OFDM-modulated Zadoff-Chu sequence that is feasible for time delay estimation. The Zadoff-Chu sequence generation may be implemented as specified in the 5G standard in TS 38.211.

An optional SL-PRS configuration may also be referred to herein as a “type of SL-PRS”.

It is expected that the configuration used by the default type of SL-PRS is not used by any optional type of PRS.

### Types of SL-PRS

It is to be understood that the Positioning Reference Signal of a “type of SL-PRS” may be generated from one of the following sequence generators: a pseudo-random sequence, such as used by an NR-PRS signal; a Zadoff-Chu sequence, such as used for an NR-SRS signal; or other complex-valued mathematical sequence which, when applied to a signal, gives rise to a new signal (e.g., the previous list of sequence generation methods is not limiting).

Taken together, the default SL-PRS configuration and the optional SL-PRS configurations may be a set of configurations known as “types of SL-PRS”.

### Signaling of Types of SL-PRS

As noted above, the default type of SL-PRS is explicitly known by the system and by the devices that optionally support dedicated Sidelink Positioning Reference Signals (SL-PRSs). As such, communications between UEs, and between UEs and the NW, indicating the type of SL-PRS that a UE can support does not need to explicitly list the default type of SL-PRS. Thus, such communications may be optimized to include only an indication of the optional type of SL-PRS that a UE can support. Such a communication may take the form of a list of optional types of SL-PRS, and the default type of PRS may not an explicit member of that list, as it is not necessary, but the inclusion of the default type of PRS in the set of types of PRS supported by the device is implied by the presence of such a list in such communications, even if the list is empty.

A possible example of capabilities of an NR System V2X-enabled device (e.g., an Anchor UE (AUE) and a target UE (TUE), as described above) with respect to the types of SL-PRS used is provided below in Table 2.

TABLE 2

| Example of capabilities of | V2X enable | V2X enable |
|---|---|---|
| NR System V2X-enabled | device | device |
| devices with respect to the | operating | operating |
| usage of Types of SL-PRS | as an AUE | as an TUE |
| Pseudo Random type SL-PRS for Tx | Optional | Optional |
| Pseudo Random type SL-PRS for Rx | Optional | Optional |
| Zadoff-Chu type SL-PRS for Tx | Optional | Optional |
| Zadoff-Chu type SL-PRS for Rx | Optional | Optional |
| The Default type SL-PRS for Tx | Yes | Yes |
| The Default type SL-PRS for Rx | Yes | Yes |

### Mapping a Positioning Reference Signal

A UE may be configured with one or more downlink PRS positioning frequency layer configurations. A PRS positioning frequency layer may be defined as a collection of PRS resource sets with each PRS resource set defining a collection of PRS resources. All of the PRS resource sets defined in the PRS positioning frequency layer may be configured with a Subcarrier Spacing parameter and a Cyclic Prefix parameter, as described below.

The subcarrier spacing for all PRS resource sets in a PRS positioning frequency layer may be specified as 15, 30, 60, or 120 kHz. The SubcarrierSpacing parameter property in the nrCarrierConfig object may be used to set the subcarrier spacing of a PRS resource set.

The cyclic prefix for all PRS resource sets in a PRS positioning frequency layer may be specified as “normal” or “extended”. The CyclicPrefix parameter property of the nrCarrierConfig object may be used to set the cyclic prefix of a PRS resource set.

To transmit the SRS in the 5G NR frames, the generated Zadoff-Chu sequence may be mapped to the given physical resources (e.g., which may include subcarriers and time slots). The mapping description may be found in chapter 6.4.1.4.3 of the 3GPP TS 38.211 specification.

The downlink positioning reference signal (PRS) is the main reference signal supporting downlink-based positioning methods. Although other signals may be used, the PRS is specifically designed to deliver the highest possible level of accuracy, coverage, and interference avoidance and suppression. The PRS signal provides a large delay spread range, since it may be received from potentially distant neighboring base stations for position (e.g., of a UE) estimation. This may be achieved by covering the whole NR bandwidth and transmitting the PRS over multiple symbols which may be aggregated to accumulate power. The duration of a PRS may be associated with the duration of a symbol that is used to transport the PRS, and the duration of such a symbol may be associated with the Subcarrier Spacing (SCS) configuration (also known as the Numerology) that is used to define the carrier configuration parameters for a specific OFDM numerology, where such a Numerology may describe the time and frequency of waveforms used by the Resource Blocks (RBs) of an NR carrier.

In NR, the density of subcarriers occupied in a given PRS symbol may be referred to as a comb size. There are several configurable comb-based PRS patterns (e.g., comb-2, -4, -6, and -12) that are suitable for different scenarios serving different use cases. For a comb-N PRS, N symbols may be combined to cover all the subcarriers in the frequency domain. By assigning a different comb set to different base stations, each base station (BS) may transmit in a different set of subcarriers to avoid interference. Since several base stations may transmit at the same time without interfering with each other, such a solution may also be latency efficient. For use cases with higher transmission loss, the PRS may also be configured to be repeated to improve the potential for a two-level reception: within a single slot and across multiple slots. Some implementations may configure the starting resource element (e.g., in the time and frequency domains) from a transmission-reception point (TRP) for a reception within a single slot. Some implementations may configure the gaps between the PRS slots, their periodicity, and their density (e.g., within a period) for a reception across multiple slots.

### Multiplexing PRS in a Slot

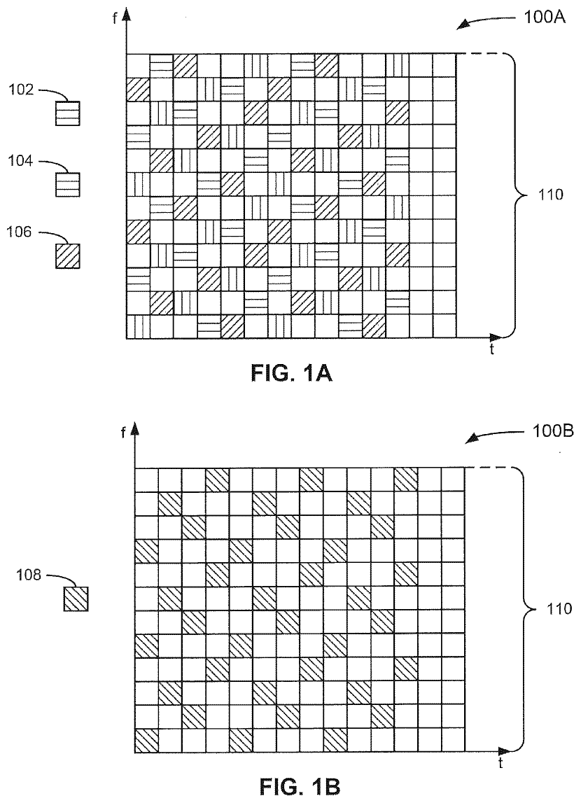

FIGS. 1A and 1B are diagrams illustrating a transmission pattern of a PRS and a transmission pattern of an SRS, respectively, according to an example implementation of the present disclosure. Specifically, FIG. 1A illustrates a time-frequency resource grid 100A in which a PRS transmission pattern (e.g., transmitted from three different base stations) in a physical resource block (PRB) 110 is shown. FIG. 1B, on the other hand, illustrates a time-frequency resource grid 100B in which a single SRS pattern (e.g., transmitted by a UE) in a PRB 110 is shown. Specifically, FIG. 1B illustrates SRS 108, which is transmitted by a UE (not shown in the figure) in a set of symbols of the resource block. In FIGS. 1A and 1B, each individual block within PRB 110 may be a resource element (RE) associated with a particular subcarrier and a particular symbol number of the slot.

For a comb-3 PRS, which is the case shown in FIG. 1A, three different symbols may be combined to cover all the subcarriers in the frequency domain. Each base station may then transmit, as shown in the figure, in different sets of subcarriers (or different sets of symbols of each subcarrier) to avoid interference with the PRS signals belonging to the other two base stations. For example, as shown in FIG. 1A, the first base station (not shown in the figure) may transmit PRS 102 in a first set of symbols, while the second base station (not shown in the figure) may transmit PRS 104 in a second set of symbols, and the third base station (not shown in the figure) may transmit PRS 106 in a third set of symbols. In some implementations, in general, for a comb-N PRS (N being a positive number), N symbols may be combined to cover all the subcarriers in the frequency domain.

In the uplink direction, the SRS for positioning may resolve two aspects specific to positioning. Since positioning involves measurements (e.g., from multiple receiving base stations), the SRS may have enough range to reach not only the serving base station (e.g., to which the UE is connected), but also the neighboring base stations that are involved in the positioning process. The SRS may also be designed to cover the full bandwidth, where the resource elements are spread across different symbols, such as to cover all subcarriers. Therefore, the SRS may also be designed with a comb-based pattern similar to the PRS. The different UEs signals may be multiplexed over the same transmitting symbol by assigning different comb patterns. To minimize the interference, a UE may be configured with different SRS instances, each having independent power control loops. This may allow the SRS pointed at neighboring cells to have better “hearability” (or reception) and may keep the interference low in the serving cell. As discussed above, an example SRS 108 transmitted by a UE is shown in FIG. 1B.

### Maximum Bandwidth

The PRS footprint on the NR time-frequency grid may be configurable with a starting physical resource block (PRB) and a PRS bandwidth. The PRS may start at any PRB in the system bandwidth and may be configured with a bandwidth ranging from 24 to 276 PRBs in steps of four PRBs. This amounts to a maximum bandwidth of about 100 MHz for a 30-kHz subcarrier spacing (30 kHz/subcarrier×12 subcarrier/PRB×276 PRB=99.360 MHz) and to about 400 MHz for a 120-kHz subcarrier spacing. The large bandwidth in 5G NR provides for a significant improvement in the time-of-arrival (TOA) accuracy compared to LTE. The maximum bandwidth in the NR V2X SL may depend on the SCS. Additionally, only one numerology (e.g., one combination of SCS and CP) may be used in a carrier at a time in the NR V2X SL.

To support UEs that cannot handle large bandwidths (e.g., due to processing limitations or high-power consumption), the concept of bandwidth part (BWP) has been introduced. A BWP may be a subset of the 100 MHz maximum bandwidth that may be configured for a 30-kHz SCS, such as in FR1, or a subset of the 400 MHz maximum bandwidth configured for a 120-kHz SCS, such as in FR2.

### Bandwidth Part

In 5G, a BWP may be a subset of contiguous common resource blocks for a given numerology. A UE may be configured with up to four DL BWPs and up to four UL BWPs for each serving cell. Per serving cell, only one BWP in the DL and one BWP in the UL may be activated at a given time (e.g., one SL BWP may be active for all the UEs in a serving cell). For the downlink, the UE may not be expected to receive outside an active BWP (e.g., except for Radio Resource Management purposes). For the uplink, the UE may not transmit outside an active BWP and for an active cell, the UE may not transmit SRSs outside an active BWP. As the sidelink transmissions and receptions of a UE are contained within the SL BWP and employ the same numerology, all physical channels, reference signals, and synchronization signals in NR V2X sidelink are transmitted within the SL BWP. This also means that the sidelink UE may not be expected to receive or transmit in a carrier with more than one numerology. In 5G, physical resource blocks (PRBs) are the RBs which are used for actual transmission/reception. A set of PRBs may belong to a single BWP. PRBs of a BWP may be numbered from 0 to a threshold size (e.g., the size of a BWP minus 1). Each BWP may have its own set of PRBs.

While the NR specification provides that NR V2X-capable UEs may use multiple carrier bandwidths, where the carrier bandwidths may occupy FR1, or FR2, or both FR1 and FR2 bands, the configuration of an SL BWP to a carrier bandwidth requires that all the SL BWPs configured in a carrier bandwidth use the same numerology. As such, an SL BWP of a Carrier Bandwidth of FR1 may not have the same numerology as an SL BWP of a Carrier Bandwidth of FR2 (e.g., except for an SCS of 60 kHz, which may be valid in both FR1 and FR2).

### Sidelink Bandwidth Part (SL BWP)

A SL BWP may occupy a contiguous portion of the bandwidth within a carrier. In a carrier, only one SL BWP may be configured for all the UEs. Sidelink transmissions and receptions of a UE may be contained within the SL BWP and may employ the same numerology. Thus, all physical channels, reference signals, and synchronization signals in NR V2X sidelink are transmitted within the SL BWP. This also means that in the sidelink, a UE is not expected to receive or transmit in a carrier with more than one numerology. The SL BWP may be divided into common RBs. A common RB may include 12 consecutive subcarriers with the same SCS, where the SCS may be given by the numerology of the SL BWP.

### Resource Pools

In NR V2X, only certain slots are configured to accommodate SL transmissions. Thus, the available sidelink resources may include slots that are allocated for sidelink (time resources) and common RBs within an SL BWP (frequency resources). In NR V2X, a subset of the available SL resources may be configured to be used by several UEs for their SL transmissions. This subset of available SL resources may be referred to as a resource pool. The common resource blocks within a resource pool are referred to as physical resource blocks (PRBs). A resource pool includes contiguous PRBs and contiguous or non-contiguous slots that have been configured for SL transmissions. A resource pool may be defined within the SL BWP. Therefore, a single numerology may be used within a resource pool. If a UE has an active UL BWP, the SL BWP may use the same numerology as the UL BWP (e.g., if they are both included in the same carrier).

### Resource Pools in the Frequency Domain

A resource pool may be divided into a configured number of contiguous subchannels, where a subchannel includes a group of consecutive PRBs in a slot. The number of PRBs in a subchannel may correspond to the subchannel size, which may be configured within a resource pool. In NR V2X SL, the subchannel size may be equal to 10, 12, 15, 20, 25, 50, 75, or 100 PRBs. A subchannel may represent the smallest unit for a sidelink data transmission or reception. A sidelink transmission may use one or multiple subchannels.

### Resource Pools in the Time Domain

The slots that are part of a resource pool may be configured and occur with a periodicity of 10,240 ms. In the time domain, the resources (e.g., slots) available for sidelink may be determined by repeating the sidelink bitmaps. The length of a bitmap may be equal to 10 bits, 11 bits, 12 bits, . . . , 160 bits. In the case of TDD communications, the resources available for sidelink may be given by a combination of the TDD pattern and the sidelink bitmap. At each slot of a resource pool, only a subset of consecutive symbols may be configured for the sidelink out of the 14 symbols per slot for a normal CP. The number of consecutive SL symbols may vary between 7 to 14 symbols depending on the physical channels that are carried within a slot.

### Resource Pool Allocations: MODE1 and MODE2

In 5G, two different modes (e.g., MODE1 and MODE2) are used for the selection of subchannels in NR V2X SL communications (e.g., when using the NR V2X PC5 interface). MODE1 and MODE2 may be equivalent to MODE3 and MODE4 in LTE V2X but may be extended to include functionality in support of groupcast and unicast communications over NR V2X SL. MODE1 refers to a centralized resource allocation via a base station (e.g., a gNB). The BS may schedule MODE1 type sidelink resources to be used by the UE for sidelink transmissions. MODE1 may apply to scenarios in which the various UEs may be inside the coverage of the BS. MODE2 may refer to autonomous allocations determined via the UE. With MODE2, the UE may autonomously determine the sidelink transmission resources within the sidelink resources configured by the BS (e.g., a gNB) or preconfigured by the network. MODE2 may apply to scenarios in which the various UEs maybe inside the coverage of the gNB, or outside the coverage of the gNB, or both.

The SL radio resources may be configured such that MODE1 and MODE2 use separate resource pools. The alternative may be that MODE1 and MODE2 share the same resource pool. In this alternative scenario, MODE1 UEs may notify MODE2 UEs of the resources allocated for their future transmissions to avoid collision of shared resources.

### Resource Pool: Pool Channels and SL-PRS

For Rel-18, it is expected that resource pools may be configured to transport SL-PRS, and that such a configuration may only provide for the transport of SL-PRS and PSCCH (e.g., no PSSCH, PSBCH or PSFCH), where the symbol location of the SL-PRS in a slot may be indicated by a PSCCH that immediately precedes the SL-PRS in the slot, and the identity of the intended recipient(s) of the SL-PRS may be indicated by the SCI of the PSCCH that immediately precedes the SL-PRS in the slot. In this type of dedicated SL-PRS configuration, the slots and subchannels of such a pool may contain only PSCCH and SL-PRS.

Alternately, for Rel-18, it is expected that resource pools may be configured to transport SL-PRS, and that such a configuration may provide for the transport of SL-PRS, PSCCH, PSSCH, PSBCH, and PSFCH. In this type of non-dedicated SL-PRS configuration, the slots and subchannels of such a pool may multiplex an SL-PRS with PSSCH, PSBCH, or PSFCH in slots and subchannels, and the identity of the intended recipient(s) of the SL-PRS may be indicated by the SCI of the PSCCH that immediately precedes the SL-PRS in the slot.

### Resource Pool: Types of SL-PRS Supported

For Rel-18, it is expected that a resource pool may be configured to use only a first type of SL-PRS sequence (e.g., only Pseudo-Random type), another resource pool may be configured to use only a second type of SL-PRS sequence (e.g., only Zadoff-Chu type), and another resource pool may be configured to use multiple types of SL-PRS sequence (e.g., Pseudo-Random and Zadoff-Chu). For example, a first resource pool may be configured to use a first type of SL-PRS sequence to align with and optimize time and frequency resources of that pool (e.g., alignment of the bands supported by the system and the device, as may be defined in a supportedBandListSidelink IE described below), a second resource pool may be configured to use a second type of SL-PRS sequence so as to minimize the PAPR of a device's transmissions on the channel used by that pool, and a third resource pool may be configured to use one or multiple types of SL-PRS sequences.

### MODE1 Resource Scheduling

MODE1 may use either a dynamic grant (DG) type of scheduling or a configured grant (CG) type of scheduling. With DG, MODE1 UEs may request the gNB to allocate resources for the transmission of every single Transport Block (TB), for example, via a Scheduling Request (SR) sent to the gNB (e.g., using the PUCCH). The gNB may respond (e.g., with downlink control information (DCI) over the PDCCH) to indicate to the UE the SL resources (e.g., the slot(s) and subchannel(s)) allocated for the transmission of a TB (and up to two possible retransmissions of this TB).

With CG scheduling, MODE1 UEs may request the gNB to allocate resources for the transmission of several TBs by first sending to the gNB a message with UE assistance information that includes information about the expected SL traffic such as: periodicity of TBs, TB maximum size and quality of service (QoS) information, etc. This information may be used by the gNB to create, configure, and allocate a CG to the UE that may satisfy the requirements of the SL traffic. The CG may be configured using a set of parameters that may include the CG index, the time-frequency allocation, and the periodicity of the allocated SL resources. A UE may be assigned a maximum number of three SL resources during each period of the CG.

For CG scheduling, there may be two types of allocation schemes for SL: CG type 1 and CG type 2. CG type 1 allocations may be utilized by the UE immediately and until it is released by the base station. CG type 2 allocations may be used only after it is activated by the gNB and until it is deactivated. The gNB notifies the UE of the activation and deactivation of type 2 CG allocations (e.g., using DCI signaling). The DCI may also include the CG index and the time-frequency allocation of a type 2 CG. A type 2 CG may configure multiple CGs for a UE and may only activate a subset of the CGs based on the UE's needs.

### MODE2 Resource Scheduling

NR V2X UEs may autonomously select their SL resources (e.g., one or several subchannels) from a resource pool when using MODE2. MODE2 UEs may operate without network coverage. A MODE2 resource pool may be configured by the gNB when the UE is in network coverage. A MODE2 UE may operate using a dynamic or a semi-persistent scheduling scheme. The dynamic scheme only selects resources for a TB while the semi-persistent scheme selects resources for a number of consecutive Reselection Counter TBs.

The dynamic scheme selects new resources for each TB and may only reserve resources for the retransmissions of that TB. A reserved resource, in some implementations, may be a selected resource that a UE reserves for a future transmission (e.g., by notifying the neighboring UEs using the first-stage SL control information (SCI)).

The semi-persistent scheme selects and reserves resources for the transmission of several TBs (and their retransmissions). The time period between the resources selected for the transmission of consecutive TBs in the semi-persistent scheme may be defined by the Resource Reservation Interval (RRI). The selected RRI may also determine the Reselection Counter that may be randomly set within an interval that depends on the selected RRI.

To select new SL resources for both dynamic and semi-persistent schemes, a UE first defines the selection window where it looks for candidate resources to transmit a TB. Once the selection window is defined, the UE may identify the candidate resources within the selection window. A candidate resource may be defined by a slot in the time domain and LPSSCH contiguous subchannels in the frequency domain (LPSSCH is the number of contiguous Physical Sidelink Shared Channels (PSSCH) in the frequency domain).

### NR V2X Sidelink Numerology

The frequencies in which NR V2X sidelink may operate are within the two following frequency ranges: (i) Frequency range 1 (FR1): 410 MHz to 7.125 GHZ, and (ii) Frequency range 2 (FR2): 24.25 GHz to 71.2 GHz. To support diverse requirements and different operating frequencies in FR1 and FR2, a scalable OFDM numerology may be provided for NR V2X (e.g., based on Rel. 15 NR Uu). Each OFDM numerology may be defined by a Subcarrier Spacing (SCS) and a Cyclic Prefix (CP). NR V2X supports multiples of 15 kHz for the SCS of the OFDM waveform. Different OFDM numerologies may be obtained with a scalable SCS given by 2^{μ}×15 kHz, where μ is an SCS configuration factor. For NR V2X, the SCS configuration factor may be μ=0, 1, 2, 3, such that the SCS may be equal to 15 kHz, 30 kHz, 60 kHz, or 120 kHz. In FR1, 15 kHz, 30 kHz, and 60 kHz may be supported for the SCS, while 60 kHz and 120 kHz may be supported for the SCS in FR2. It should be noted that only the 60 kHz SCS configuration may be supported in both FR1 and FR2.

### NR V2X Sidelink Physical Layer Structure

Transmissions in NR V2X SL use the orthogonal frequency division multiplexing (OFDM) waveform with a CP. The sidelink frame structure may be organized in radio frames (also may be referred as frames), each with a duration of 10 ms. A radio frame may be divided into 10 subframes, each with a duration of 1 ms. The number of slots per subframe and the SCS for the OFDM waveform may be flexible for NR V2X (e.g., a subframe may have 1, 2, 4, or 8 slots per subframe, based on the SCS, resulting in a variable slot duration of 1 ms, 0.5 ms, 0.25 ms, or 0.0125 ms for an SCS of 15 kHz, 30 kHz, 60 kHz, or 120 kHz, respectively). It is noted that the smallest unit of time for scheduling SL transmissions in NR V2X is a slot.

### Sidelink Positioning Definitions

A Sidelink Positioning Group (SPG) is a set of V2X-enabled UEs that form a group for the purpose of positioning. The group of UEs send and receive SL-PRSs and calculate the position of the Target UE (defined below) based on the measurement done by the UEs. Neither a Uu link nor a network-based location server is involved in the sidelink positioning process. Instead, the positioning process is fully distributed based on the positioning group. In one architecture, the Anchor UE (also defined below) of the group can assume the role of a location server.

An Anchor UE (AUE) is a UE whose location is known and is used to locate Target UEs of an SPG. In one architecture, the AUE of the group may take the role of a location server. The AUE participates in sidelink positioning and helps the Target UEs of the SPG to acquire the position of the AUE by sending/receiving SL-PRS and doing relevant measurements. The absolute position of the AUE is known for absolute sidelink positioning, but it is not necessary for relative sidelink positioning.

A Target UE (TUE) is a UE that is associated with an SPG administered by an AUE. A Location Management Function (LMF) is a network entity defined in a 5G Core Network to provide positioning functionality by means to determine the geographic position of a mobile device based on downlink and uplink location-measuring radio signals.

### NR System Information

A UE receives a resource pool configuration and an SL DRB configuration via System Information Block (SIB) 12 for NR sidelink communication (e.g., as specified in TS 38.331) and/or resource pool configuration via SIB13 and SIB14 for V2X sidelink communication (e.g., also as specified in TS 38.331).

System Information (SI) in NR includes a Master Information Block (MIB) and a number of System Information Blocks (SIBs), which are divided into Minimum SI and Other SI. Minimum SI carries basic information required for initial access and for acquiring any other SI. Minimum SI includes MIB and SIB1. For a UE to be allowed to camp on a cell, it may have acquired the contents of the Minimum SI from that cell. Other SI includes all SIBs not broadcast in the Minimum SI. The UE may not need to receive these SIBs before accessing the cell.

The content and scheduling of the minimum SI of MIB and SIB1 may be as indicated below.

The MIB may provide for a System Frame Number (SFN), critical information for the reception of SIB1 (e.g., SCS, subcarrier offset, Demodulation Reference Signal (DMRS) position, and/or PDCCH configuration), a cell barred flag, and/or an intra-frequency reselection allowed flag. The MIB may be mapped on to a Broadcast Control Channel (BCCH) logical channel and may be carried on a Broadcast Channel (BCH) transport channel. The BCH is then mapped onto a Physical Broadcast Channel (PBCH).

The MIB may be transmitted with a periodicity of 80 ms and may be repeated (according to Synchronization Signal Block (SSB) periodicity) within the 80 ms. MIB contents may be the same over the 80 ms period, and the same MIB may be transmitted over all SSBs within the Synchronization Signal (SS) burst set. The MIB may provide the UE with parameters (e.g., Control Resource Set #0 (CORESET #0) configuration) required to acquire SIB1 (e.g., more specifically, information useful for monitoring of a PDCCH for scheduling a PDSCH that carries SIB1).

SIB1 may provide cell selection information, a Public Land Mobile Network (PLMN) list, cell ID, tracking area code, RAN area code, cell reserved flag, connection establishment failure control information, SI scheduling information, serving cell common uplink and downlink configurations (e.g., configuration information for a Random Access Channel (RACH), paging, etc.), Supplementary UL (SUL) configuration, SSB scheduling information, cell-specific TDD UL/DL configurations, a cell's IMS emergency bearer support flag (e.g., for UEs in limited service), emergency call over Internet Protocol (IP) Multimedia Subsystem (IMS) support flag, a UE's timers and constants, access control information, etc.

The SIB1 may carry the most critical information required for the UE to access the cell (e.g., random access parameters). The SIB1 may include information regarding the availability and scheduling of other SIBs (e.g., mapping of SIBs to SI message, periodicity, SI window size, etc.) SIB1 may also indicate whether one or more SIBs are only provided on-demand, in which case SIB1 may also provide a PRACH configuration needed by the UE to request the required SI. The SIB1 may be transmitted on the Downlink Shared Channel (DL-SCH (e.g., a logical channel-BCCH)) with a periodicity of 160 ms and variable transmission repetition periodicity within 160 ms. The SIB1 may be a cell-specific SIB.

The UE may acquire the SI upon cell selection (e.g., upon power on), cell reselection, return from out of coverage, after reconfiguration with sync completion, after entering the network from another Radio Access Technology (RAT), upon receiving an indication that the SI has changed, upon receiving a PWS (Public Warning System) notification, and/or whenever the UE does not have a valid version of a stored SIB.

### SIBS on Demand

For NR, two different types of SIBs may be employed. One type is transmitted periodically, like the SIBs in LTE; the other type is transmitted in response to a request from a UE. In NR, the MIB and SIB1 (e.g., the minimum SI) may always be transmitted periodically using broadcast resources, then, depending on the state of a flag in SIB1, the remaining SIBs may also be transmitted periodically and obtained from broadcast resources (e.g., SIB1). Otherwise, the state of the flag in SIB1 may indicate that the remaining SIBs of the system are acquired by the UE via a request to the gNB using Radio Resource Control (RRC) signaling. The remaining NR SIBs may be described as follows:
SIB2 may carry cell reselection criteria.
SIB3 may carry an NR intra-frequency neighbor cell list and associated reselection criteria.
SIB4 may carry an NR inter-frequency neighbor cell list and associated reselection criteria.
SIB5 may carry an E-UTRA neighbor cell list and associated reselection criteria.
SIB6 may carry Earthquake and Tsunami Warning System (ETWS) notification information.
SIB7 may carry ETWS secondary notification information.
SIB8 may carry Commercial Mobile Alert System (CMAS) notification information.
SIB9 may carry Global Positioning System (GPS) time and Coordinated Universal Time (UTC) information.
SIB10 may carry the Human-Readable Network Names (HRNNs) of the Non-Public Networks (NPNs) listed in SIB1.
SIB11 may carry information related to idle/inactive measurements.
SIB12 may carry NR sidelink communication configurations.
SIB13 may carry configurations of V2X sidelink communications (e.g., as defined in TS 36.311).
SIB14 may carry configurations of V2X sidelink communications (e.g., as defined in TS 36.311), which may be joined with the information included in SIB13.
SIB15 may carry configurations of disaster roaming information.
SIB16 may carry configurations of slice-specific cell reselection information.
SIB17 may carry configurations of Tracking Reference Signal (TRS) resources for idle/inactive UEs.
SIB18 may carry Group IDs for Network selection (GINs) to support access using credentials from a credentials holder or to enable UE onboarding. SIB18 may only be present if there is at least one Standalone Non-Public Network (SNPN) that supports either access using a credentials holder or UE onboarding.
SIB19 may carry satellite assistance information.
SIB20 may carry information required to acquire the Multicast Control Channel (MCCH) configuration for Multicast and Broadcast Services (MBS) broadcast.
SIB21 may carry the mapping between frequency and MBS.

### UE Assistance Information

UE Assistance Information may be a mechanism by which a UE can inform the NW (or a peer UE, in the case of V2X communications) of its various internal statuses so that the NW (or peer UE) can assign and/or control resources to better fit the specific RF, operational, or other conditions of the UE sending the assistance information message. The mechanism may use a UEAssistanceInformation message for a UE to inform the NW of its various internal statuses. The mechanism may use a UEAssistanceInformationSidelink message for a UE to inform a peer UE of its various internal statuses.

### Possible Sidelink Positioning Enhancements

As mentioned above, enhancements to positioning techniques may be achieved by taking advantage of the wider bandwidths provided by NR via FR1 and FR2. The availability of wider bandwidth also indicates that a communication channel that uses all (or even part of) the wider bandwidth will encounter more diverse radio frequency (RF) characteristic, thus requiring a more complex receiver for the device. Designing a single Positioning Reference Signal (PRS) to operate in such a wide channel may not be optimal for all channel conditions, all available resource allocations, and/or all device capabilities. For example, the service level that a device is able to provide may not support full utilization of the FR1 and FR2 bands. Consequently, two or more PRSs may be needed and designed, in which, for example, a first signal may be optimized for a specific set of operating conditions of the sidelink channel and available sidelink resource, and another signal may be optimized for a minimum service level of a device.

It is expected that when the Rel-18 NR dedicated Sidelink Positioning Reference Signal (SL-PRS) for positioning purposes is enabled in a network, in addition to employing a “default” type of SL-PRS (described in greater detail below), one or more “optional” types of SL-PRS may also be available, wherein fewer than all UEs that are associated with a Sidelink Positioning Group (SPG) will be capable of transmission, reception, and processing of all of the possible optional types of SL-PRS.

For example, some of the UEs associated with an SPG may have a higher level of sophistication (e.g., service level) then other UEs associated with the same SPG. Such UEs with a higher level of sophistication may be able to transmit, receive, and process multiple types of SL-PRS signals (e.g., a Pseudo-Random sequence, as used by NR-PRS, a Zadoff-Chu sequence, as used by NR-SRS, and other sequences), while other, less sophisticated UEs may only be able to transmit, receive, and process a single Type of SL-PRS (e.g., a Zadoff-Chu sequence, as used by NR-SRS).

Consequently, for an Anchor UE (AUE) that is administering an SPG to service all Target UEs (TUE) associated with the SPG with at least one type of SL-PRS (e.g., including both default and optional types) that is common to all TUEs and the AUE, there is a need for each UE (or device) that requests the AUE to associate the UE with the SPG to send information to the AUE regarding the service level the UE can support or is compatible with (in other words, the UE's capabilities) prior to the AUE granting the UE's association with the SPG. Such a service level support indication may include the types of SL-PRS that the device can transmit, receive, and process, as well as the frequency bands in which the UE may support the types of SL-PRS.

Once a device has been associated with an SPG administered by an AUE, the device is known as a Targeting UE (TUE). A TUE may request the AUE to use a specific type of SL-PRS. Such a request by the TUE for a specific type of SL-PRS to be used by the AUE may be related to, for example, the RF condition currently experienced by the TUE. However, an AUE may or may not be able to support a TUE's request for the specific type of SL-PRS requested. If, for example, one or more of the other TUEs of the SPG to which the requesting TUE is associated cannot support the requested type of SL-PRS, then the AUE should not change the type of SL-PRS that the SPG is currently using. In other examples, the AUE may not be able to support a TUE's request for a specific type of SL-PRS if the AUE is not capable of transmitting or receiving the requested type of SL-PRS, or the AUE may not have the resources necessary to support the requested type of SL-PRS. Accordingly, another need exists to facilitate communication between a TUE and an AUE regarding a request by a TUE to use a specific type of SL-PRS.

In Rel-17, an SCCH-Message class is a set of RRC messages that may be transmitted from V2X-enabled peer UE to V2X-enabled peer UE for NR sidelink communication on an SCCH logical channel. For example, a V2X-enabled UE can send to a peer V2X-enabled UE, via an SCCH-Message, a sidelink inter-UE communication UECapabilityInformationSidelink message that may be used to inform the receiving UE of the sidelink capabilities information of the transmitting UE.

In another example, a V2X-enabled UE can send to a peer V2X-enabled UE, via an SCCH-Message, a sidelink inter-UE communication UEAssistanceInformationSidelink message that may be used to transfer an internal status of the transmitting UE to the receiving UE so that the receiving UE or the NW may can assign and/or control resources to better fit the specific RF conditions, operational conditions, or other conditions of the transmitting UE.

According to various implementations of the present disclosure, mechanisms are discussed below by which one or more new types of information (e.g., new IEs in messages transmitted between UEs) may be employed to address the above-referenced needs.

For example, the UECapabilityInformationSidelink message may be enhanced to transport a new IE that includes a list of types of SL-PRS that a UE is capable of transmitting, receiving, and/or processing. In some implementations, the new IE (e.g., a sidelinkPRS-TypeList-r18 IE, an example of which is described in greater detail below) may be used by a first UE to inform a second UE of the capabilities of the first UE with respect to transmission, reception, and/or processing a specific set of types of SL-PRS. In some implementations, the new IE may be defined to contain a set of optional types of SL-PRS. Also, in some implementations, the new IE may indicate frequency bands supported by the optional types of SL-PRS. In some implementations, the new IE may indicate to the receiving UE (e.g., the second UE) that the transmitting UE (e.g., the first UE) supports SL-PRSs when the new IE is present in the UECapabilityInformationSidelink message. Further, in some implementations, the new IE may be defined to not explicitly include the default type of SL-PRS mentioned above, even though the transmitting UE supports the default type of SL-PRS. Additionally, in some implementations, the UECapabilityInformationSidelink message, when not including a sidelinkPRS-TypeList-r18 IE, may indicate that the transmitting UE does not support SL-PRS functionality.

In another example, the UEAssistanceInformationSidelink message may be enhanced to transport a new IE that includes a particular type of SL-PRS that a UE is capable of transmitting, receiving, and/or processing. In some implementations, the new IE (e.g., a SidelinkPRS-Type-r18 IE, an example of which is described in greater detail below) may be used by a first (Target) UE (or TUE) to request a second (Anchor) UE (or AUE) to use the particular type of SL-PRS for an SPG administered by the AUE and to which the TUE is associated. In some implementations, after transmission of the UEAssistanceInformationSidelink message including the new IE, if the AUE does not transmit the requested type of SL-PRS in the next slot in which the AUE would normally transmit an SL-PRS for the SPG, then the requesting TUE may start a Prohibit Timer. Presuming the Prohibit Timer is started, then until the expiration of the Prohibit Timer, the TUE that made the request may not be permitted to make another request to the same AUE of the same SPG for the same type of SL-PRS. In some implementations, the Prohibit Timer may be reset prior to expiration if the TUE becomes associated with another SPG of another AUE. In some implementations, the new IE may be defined to contain an optional type of SL-PRS. Also, in some implementations, the new IE may indicate frequency bands supported by the optional type of SL-PRS. In some implementations, the new IE may be defined to not explicitly include the default type of SL-PRS mentioned above, even though the TUE supports the default type of SL-PRS. Further, in some implementations, by transmitting a UEAssistanceInformationSidelink message without a SidelinkPRS-Type-r18 IE, the transmitting UE may not be indicating anything regarding its possible support of SL-PRS functionality.

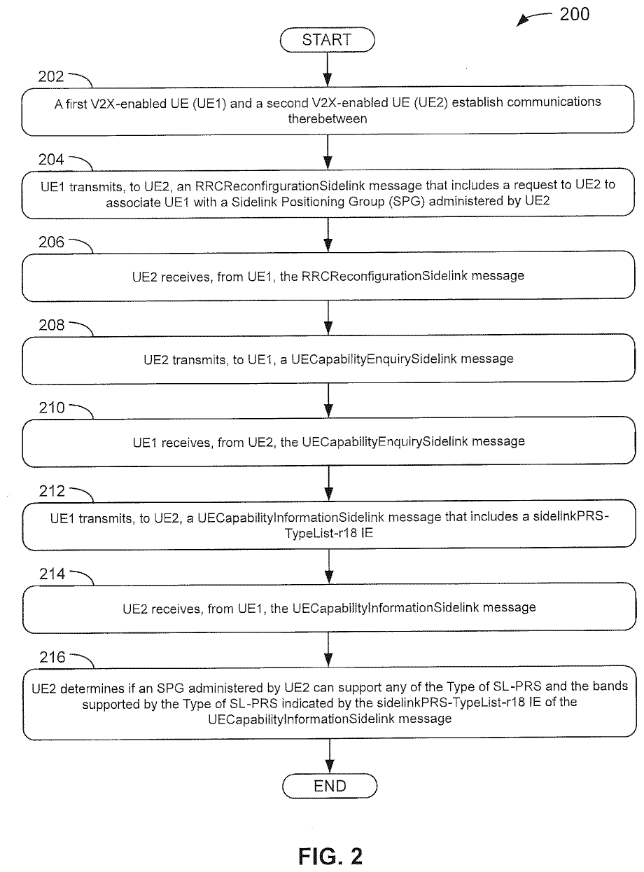

In FIGS. 2-10 and the accompanying descriptions below, references are made to UE1 and UE2. Depending on the particular circumstances being discussed, UE1 may be a UE attempting association with an SPG or a Target UE (TUE) currently associated with an SPG. Also, in these same descriptions, UE2 may be an Anchor UE (AUE) administering the SPG.

Moreover, with respect to FIGS. 2-10, while a particular set of operations is depicted and described, greater or fewer operations than those shown may be performed. Also, while a particular order for the depicted operations is shown, other orders of execution may also be possible.

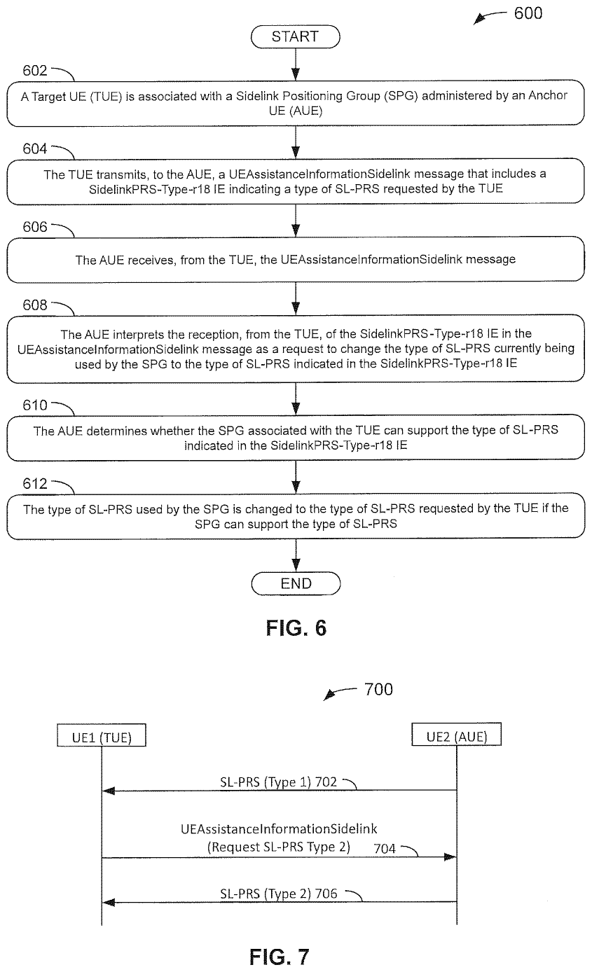

Also, regarding FIGS. 2-10, FIGS. 2-5 illustrate various implementations regarding a UE (e.g., UE1) requesting an AUE (e.g., UE2) to associate the UE with an SPG administered by the AUE. Thereafter, FIGS. 6-10 illustrate various implementations involving a TUE (e.g., UE1) requesting an AUE (e.g., UE2) to change a type of SL-PRS employed in the SPG administered by the AUE.

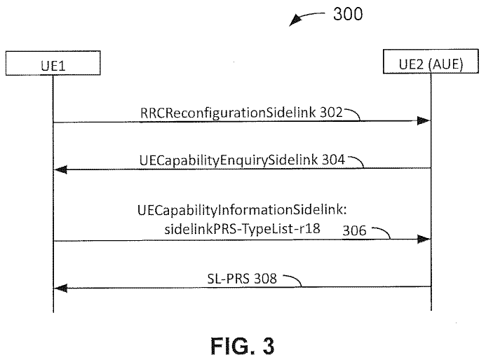

FIG. 2 is a flowchart illustrating a method 200 performed by a UE and an AUE administering an SPG to authorize the UE to join the SPG, according to an example implementation of the present disclosure. In addition, FIG. 3 is a communication diagram 300 illustrating communications occurring between the UE and the AUE during the method 200 of FIG. 2, according to an example implementation of the present disclosure.

In the method 200, at operation 202, a first V2X-enabled UE (e.g., UE1) and a second V2X-enabled UE (UE2, serving as the AUE of an SPG) may establish communication therebetween. Thereafter, at operation 204, UE1 may transmit, to UE2, an RRCReconfigurationSidelink message (e.g., RRCReconfigurationSidelink message 302 of FIG. 3) that includes a request to UE2 to associate UE1 with the SPG administered by UE2. Accordingly, at operation 206, UE2 may receive, from UE1, the RRCReconfigurationSidelink message 302.

In response to receiving RRCReconfigurationSidelink message 302, UE2, at operation 208, may transmit, to UE1, a UECapabilityEnquirySidelink message (e.g., UECapabilityEnquirySidelink message 304 of FIG. 3), which requests UE1 to provide capability information related to the types of SL-PRS with which UE1 is compatible. Thereafter, at operation 210, UE1 may receive, from UE2, UECapabilityEnquirySidelink message 304.

In response to receiving UECapabilityEnquirySidelink message 304, UE1, at operation 212, may transmit, to UE2, a UECapabilityInformationSidelink message (e.g., UECapabilityInformationSidelink message 306 of FIG. 3) that includes a new IE (e.g., a sidelinkPRS-TypeList-r18 IE, described in greater detail below) that may provide a list of zero or more optional types of SL-PRS with which UE1 is compatible (e.g., types of SL-PRS that UE1 may be capable of transmitting, receiving, and/or processing). Thereafter, at operation 214, UE2 may receive, from UE1, UECapabilityInformationSidelink message 306.

In some implementations, the sidelinkPRS-TypeList-r18 IE may further include an element for each optional type of SL-PRS with which UE1 is compatible, with each element being defined by a corresponding second new IE (e.g., a SidelinkPRSType-r18 IE, also discussed more fully below). In addition, in some implementations, a third new IE (e.g., a supportedBandListSidelinkPRS-r18 IE, described in greater detail below) corresponding to each SidelinkPRS-Type-r18 IE may be included in the sidelinkPRS-TypeList-r18 IE to define one or more frequency bands supported for each optional type of SL-PRS listed.

In some implementations, the sidelinkPRS-TypeList-r18 IE may not include the default type of SL-PRS typically expected of a UE to be associated with an SPG. Consequently, in some embodiments, the sidelinkPRS-TypeList-r18 IE may include no entries (e.g., may be empty) in UECapabilityInformationSidelink message 306; in such cases, UE2 may presume that UE1 is capable of transmitting, receiving, and/or processing the default SL-PRS. Also, in some implementations, a UECapabilityInformationSidelink message 306 without a sidelinkPRS-TypeList-r18 IE may indicate to UE2 that UE1 does not support SL-PRS functionality.

More generally, for purposes of the present disclosure, “types of SL-PRS” generally refers to a set of SL-PRS that includes both the default type of SL-PRS and the optional types of SL-PRS explicitly indicated by a UE, unless explicitly indicated otherwise herein.

Returning to FIG. 2, at operation 216, UE2 determines if an SPG it administers can support any of the (default and optional) types of SL-PRS and their corresponding supported frequency bands, as indicated in the received sidelinkPRS-TypeList-r18 IE. If so, UE2, as the AUE, associates UE 1 with the identified SPG. In that case, UE2 may select and transmit a compatible (default or optional) type of SL-PRS (e.g., SL-PRS 308 of FIG. 3) to UE1 and other UEs associated with the SPG.

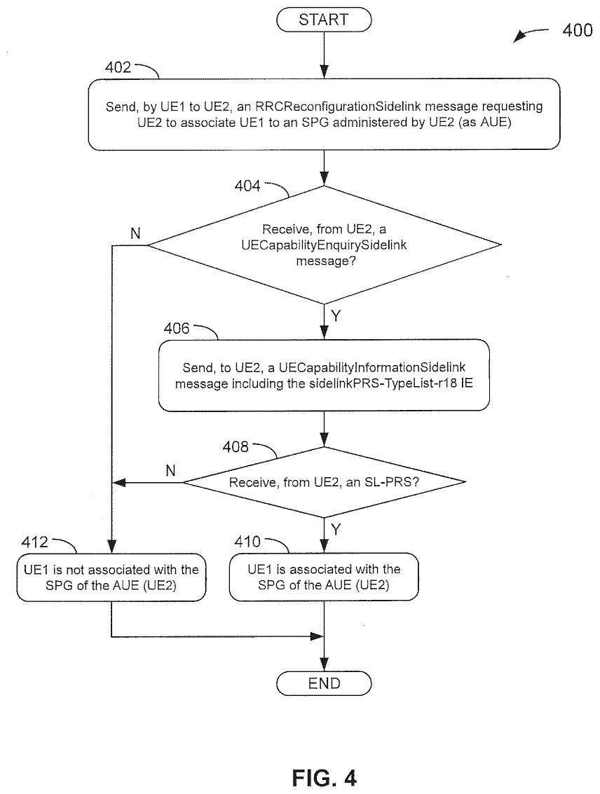

FIG. 4 is a flowchart illustrating a method 400 performed by a UE to join an SPG administered by an AUE, according to an example implementation of the present disclosure (e.g., associated with the method 200 of FIG. 2 and the communication diagram 300 of FIG. 3). In the method 400, at operation 402, a first device (UE1) may send, to a second device (UE2), an RRCReconfigurationSidelink message requesting UE2 to associate UE1 to an SPG administered by UE2 (e.g., as an AUE). At operation 404, if UE1 does not receive, from UE2, a UECapabilityEnquirySidelink message in response to the RRCReconfigurationSidelink message (e.g., within some period of time), UE1 proceeds to operation 412, in which UE1 is not associated with an SPG administered by UE2. Method 400 may then terminate.

If, instead, UE1 receives, from UE2, a UECapabilityEnquirySidelink message at operation 404, the UE1 may then transmit, at operation 406, a UECapabilityInformationSidelink message including a sidelinkPRS-TypeList-r18 IE that provides a list of zero or more optional types of SL-PRS with which UE1 is compatible, as described above.

At operation 408, if UE1 does not receive, from UE2, an SL-PRS corresponding to an SPG administered by UE2 in response to the UECapabilityInformationSidelink message (e.g., within some period of time), UE1 proceeds to operation 412, in which UE1 is not associated with an SPG administered by UE2. Method 400 may then terminate.

If, instead, UE1 receives, from UE2, an SL-PRS corresponding to an SPG administered by UE2 in response to the UECapabilityInformationSidelink message, UE1 proceeds to operation 410, in which UE1 recognizes its association with the SPG administered by the UE2 (as the AUE of the SPG), after which method 400 may then terminate.

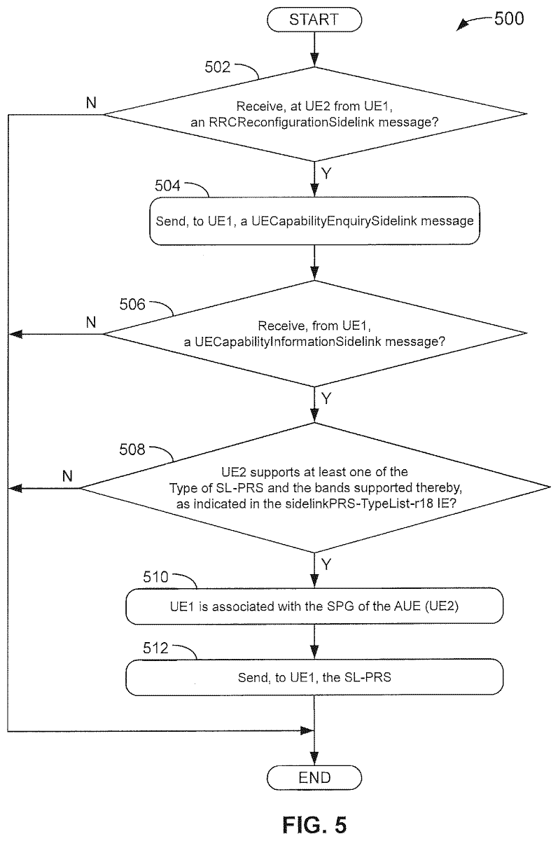

FIG. 5 is a flowchart illustrating a method 500 performed by an AUE (e.g., UE2) to authorize another UE (e.g., UE1) to join an SPG administered by the AUE, according to an example implementation of the present disclosure (e.g., associated with the method 200 of FIG. 2 and the communication diagram 300 of FIG. 3). In the method 500, at operation 502, UE2 determines if an RRCReconfigurationSidelink message has been received from UE1. If not, method 500 may end. Otherwise, if UE2 has received an RRCReconfigurationSidelink message from UE1, UE2 may proceed to operation 504, in which UE2 transmits, to UE1, a UECapabilityEnquirySidelink message.

Thereafter, at operation 506, if UE2 has not received a UECapabilityInformationSidelink message (e.g., including a sidelinkPRS-TypeList-r18 IE that provides a list of zero or more optional types of SL-PRS with which UE1 is compatible, as described above), method 500 may terminate. Otherwise, if UE2 has received the UECapabilityInformationSidelink message, UE2 proceeds to operation 508, in which UE2 determines whether UE2 supports at least one of the optional types of SL-PRS and the corresponding frequency bands indicated in the sidelinkPRS-TypeList-r18 IE for any SPG administered by UE2. In some implementations, the types of SL-PRS considered by UE2 include any optional types of SL-PRS listed in sidelinkPRS-TypeList-r18, as well as the default SL-PRS. If UE2 does not support any of the (optional or default) types of SL-PRS in any SPG administered by UE2, method 500 may terminate. Otherwise, UE2 may proceed to operation 510, in which UE2 associates UE1 with an SPG administered by UE2 that is compatible with one of the types of SL-PRS indicated in sidelinkPRS-TypeList-r18. Thereafter, at operation 512, UE2 may transmit, to UE1, the SL-PRS of that type. In some implementations, UE2 may transmit SL-PRS periodically as part of normal operations for the SPG. Method 500 may then terminate.

To operate in accordance with the implementations discussed above in conjunction with FIGS. 2-5, a communication system and its various components may include the following:

A communication system capable of supporting the use of one or more types of SL-PRS (e.g., a pseudo-random sequence, a Zadoff-Chu sequence, and/or others) by a V2X-enabled UE that may operate as an Anchor UE (AUE) that may be attached to the system via a Uu interface and/or by a V2X-enabled UE that may operate as a Target UE (TUE) attached to the AUE via a PC5 interface.

A gNB of the system capable of configuring an AUE with a pool of RF resources used by the AUE for the transmission and reception of SL-PRSs by the AUE and TUEs.

A SIB of the system broadcast by a gNB of the system, where the SIB configures a AUE with a pool of RF resources used by the AUE for the transmission and reception of SL-PRSs by the AUE and TUEs.

An AUE of the system capable of supporting the transmission and reception of one or more types of SL-PRS to one or more TUEs.

A TUE of the system capable of supporting the transmission and reception of one or more types of SL-PRS to one or more AUEs.

An AUE of the system capable of hosting one or more SPGs concurrently.

An AUE of the system capable of creating an SPG with the support and coordination of a gNB while in-coverage of the system and while not in-coverage of the system.

An AUE of the system capable of creating an SPG without the support and coordination of a gNB while not in-coverage of the system.

An AUE of the system capable of accepting a request from a device seeking to be associated with an SPG.

An AUE of the system capable of obtaining the capability (CAP) of a device, where the CAP of the device is obtained by the AUE via a sidelink message exchange between the AUE and the device via a PC5 interface. In some implementations, the CAP exchange between the AUE and the device includes one or more types of SL-PRS supported by the device.

An AUE of the system capable of determining the suitability of a device to be associated with an SPG with the support and coordination of a gNB while in-coverage of the system and while not in-coverage of the system. In some implementations, the determination may take into account the SL-PRS resources available to the AUE and/or the types of SL-PRS supported by the device.

An AUE of the system capable of assigning a device to an SPG with the support and coordination of a gNB while in-coverage of the system and while not in-coverage of the system.

An AUE of the system capable of assigning a device to an SPG without the support and coordination of a gNB while not in-coverage of the system. It is noted that once a device is assigned to an SPG, the device may meet the definition of a TUE of the SPG.

An AUE of the system capable of assigning RF resources for the transmission of SL-PRSs by the AUE while in-coverage of the system, where the RF resources are allocated to the AUE by the gNB or by SIB, and where the RF resources are a subset of a pool of RF resources configured for the AUE by the gNB of the system or by a SIB of the system.

An AUE of the system capable of assigning RF resources for the transmission of SL-PRSs by the AUE to the one or more SPGs hosted by the AUE while not in-coverage of the system, where the RF resources are pre-allocated to the AUE by the gNB or by SIB when the AUE was last in-coverage.

An AUE of the system capable of assigning RF resources for the transmission of SL-PRSs by the TUEs associated with one or more SPGs administered by the AUE while not in-coverage of the system, where the RF resources are pre-allocated to the AUE by the gNB or by SIB when the AUE was last in-coverage.

An AUE of the system capable of transmitting an SL-PRS to the TUEs associated with one or more SPGs administered by the AUE, with the support and coordination of a gNB while in-coverage of the system and while not in-coverage of the system.

An AUE of the system capable of transmitting an SL-PRS to the TUEs associated with one or more SPGs administered by the AUE, without the support and coordination of a gNB while not in-coverage of the system.

An AUE of the system capable of receiving SL-PRSs from the TUEs associated with one or more SPGs administered by the AUE, with the support and coordination of a gNB while in-coverage of the system and while not in-coverage of the system.

An AUE of the system capable of receiving SL-PRSs from the TUEs associated with one or more SPGs administered by that AUE, without the support and coordination of a gNB while not in-coverage of the system.

A TUE of the system capable of transmitting an SL-PRS to the AUE administering the SPG with which the TUE is associated, with the support and coordination of a gNB while in-coverage of the system, and while not in-coverage of the system.

A TUE of the system capable of transmitting an SL-PRS to the AUE administering the SPG with which the TUE is associated, without the support and coordination of a gNB while not in-coverage of the system.

A TUE of the system capable of receiving an SL-PRS from the AUE administering the SPG with which the TUE is associated, with the support and coordination of a gNB while in-coverage of the system, and while not in-coverage of the system.

A TUE of the system capable of receiving an SL-PRS from the AUE administering the SPG with which the TUE is associated, without the support and coordination of a gNB while not in-coverage of the system.

FIGS. 6-10 illustrate various implementations involving a TUE (e.g., UE1) requesting an AUE (e.g., UE2) to change a type of SL-PRS employed in the SPG administered by the AUE, as mentioned above.

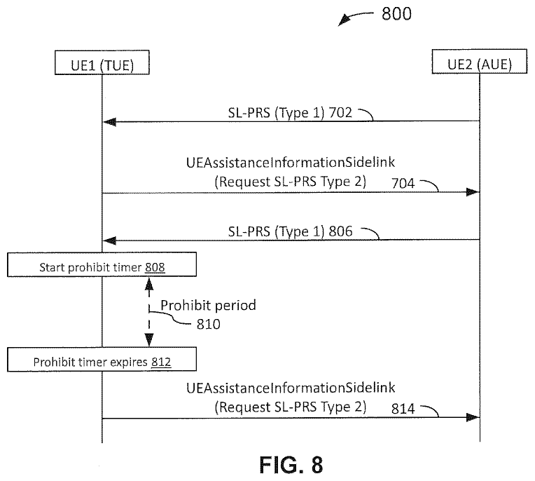

FIG. 6 is a flowchart illustrating a method 600 performed by a TUE and an AUE of an SPG to change a type of SL-PRS used by the SPG at the request of the TUE, according to an example implementation of the present disclosure. In addition, FIG. 7 is a communication diagram 700 illustrating communications occurring between the TUE and the AUE during the method 600 of FIG. 6, when the change of the type of SL-PRS is successful, according to an example implementation of the present disclosure. Also, FIG. 8 is a communication diagram 800 illustrating communications occurring between the TUE and the AUE during the method 600 of FIG. 6, when the change of the type of SL-PRS is unsuccessful, according to an example implementation of the present disclosure.

In the method 600, at operation 602, a TUE may be associated with an SPG administered by an AUE. In some implementations, the associating of the TUE with the SPG may be accomplished as described above in conjunction with FIGS. 2-5. During this time, the AUE may periodically transmit an SL-PRS of Type 1 702 (shown in FIGS. 7 and 8) (e.g., the default SL-PRS or an optional SL-PRS) to the TUE, as well as to other TUEs of the SPG.

At operation 604, the TUE may transmit, to the AUE, a UEAssistanceInformationSidelink message (e.g., UEAssistanceInformationSidelink message 704 of FIGS. 7 and 8). As a result, at operation 606, the AUE may receive the UEAssistanceInformationSidelink message transmitted by the TUE.

In some implementations, the UEAssistanceInformationSidelink message may include a SidelinkPRS-Type-r18 IE and a corresponding supportedBandListSidelink-r18 IE (e.g., as described above). More specifically, the SidelinkPRS-Type-r18 IE may indicate a particular optional type of SL-PRS with which the TUE is compatible (e.g., the TUE may transmit, receive, and/or process the indicated type of SL-PRS), and the supportedBandListSidelink-r18 IE may define one or more frequency bands supported for the indicated type of SL-PRS.

In some implementations, if the TUE requests that the AUE use the default type of SL-PRS, then the TUE may send the AUE a UEAssistanceInformationSidelink message that contains an empty SidelinkPRS-Type-r18 IE. If the TUE requests that the AUE use one of the optional types of SL-PRS, then the TUE may send to the AUE a UEAssistanceInformationSidelink message that includes a SidelinkPRS-Type-r18 IE that specifies the requested optional type of SL-PRS and includes the supportedBandListSidelink-r18 IE to define the frequency bands supported by the indicated optional type of SL-PRS.

At operation 608, the AUE may interpret the reception, from the TUE, of the SidelinkPRS-Type-r18 IE in the UEAssistanceInformationSidelink message as a request to change the type of SL-PRS currently being used by the SPG to the type of SL-PRS indicated in the SidelinkPRS-Type-r18 IE. Accordingly, at operation 610, the AUE may determine whether the SPG associated with the TUE can support the type of SL-PRS indicated in the SidelinkPRS-Type-r18 IE.

More specifically, in some implementations, the AUE may consider the type of SL-PRS requested by the TUE (e.g., the optional SL-PRS explicitly indicated in the SidelinkPRS-Type-r18 IE, or the default SL-PRS if the SidelinkPRS-Type-r18 IE is empty in the UEAssistanceInformationSidelink message) and the frequency bands supported by the type of SL-PRS requested (e.g., as indicated in the supportedBandListSidelinkPRS-r18 IE) and compare that information with the types and bands of the SL-PRS that other TUEs associated with the SPG of the AUE can support.

Thereafter, at operation 612, if the SPG can support the default or optional type of SL-PRS indicated by the TUE in the UEAssistanceInformationSidelink message, the AUE may change the type of SL-PRS currently employed in the SPG to the type of SL-PRS indicated by the TUE. In some implementations, if TUEs of the SPG administered by the AUE can support the type of SL-PRS requested by the TUE, as well as the frequency bands supported by the type of SL-PRS, the AUE may begin transmission of the requested type of SL-PRS at the start of the next regularly scheduled slot that would carry an SL-PRS for the administered SPG (e.g., SL-PRS 706 of Type 2, as shown in FIG. 7).

If, instead, the TUEs of the SPG administered by the AUE cannot support the type of SL-PRS or the bands supported by the type of SL-PRS requested by the TUE, the AUE may not begin transmission of the requested type of SL-PRS at the start of the next regularly scheduled slot that would carry an SL-PRS for the administered SPG. Instead, the AUE may continue to transmit the type of SL-PRS currently being employed in the SPG (e.g., SL-PRS (Type 1) 806 of FIG. 8).

In some implementations, a TUE that requests an AUE to use a specific type of SL-PRS for a SPG administered by the AUE via the UEAssistanceInformationSidelink message, upon detection that the SL-PRS transmitted in the next regularly scheduled slot is not the type of SL-PRS requested (e.g., SL-PRS 806 of Type 1, as shown in FIG. 8), may start a Prohibit Timer (e.g., operation 808 of FIG. 8). In some implementations, if the TUE starts the Prohibit Timer, then until the expiration of the Prohibit Timer (e.g., operation 812 of FIG. 8), the TUE that made the request may not be permitted to make another request to the same SPG of the same AUE for the same type of SL-PRS (e.g., during a Prohibit Period 810 of FIG. 8). In some implementations, the Prohibit Timer may be reset if the TUE becomes associated with another SPG of the AUE or another AUE. Also, in some implementations, the TUE may request another SL-PRS for the SPG administered by the AUE that is different from the type of SL-PRS initially requested by the TUE. After the Prohibit Period, the TUE may transmit another UEAssistanceInformationSidelink message, again requesting an SL-PRS of Type 2 (e.g., UEAssistanceInformationSidelink message 814 of FIG. 8).

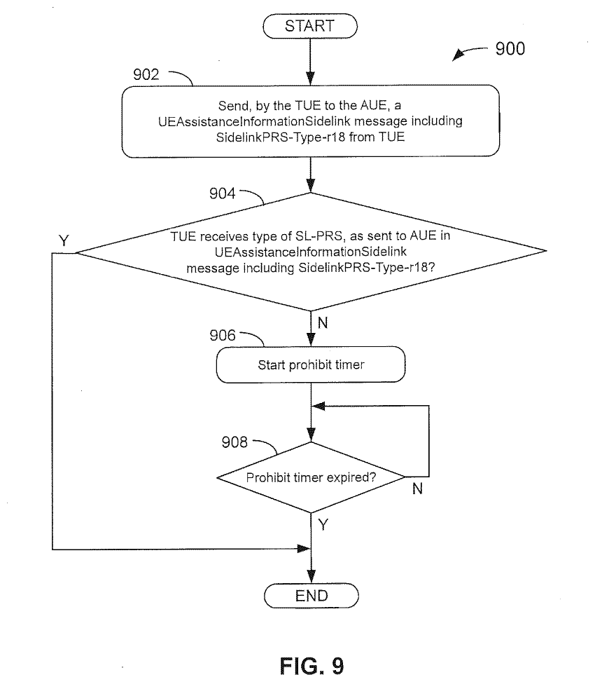

FIG. 9 is a flowchart illustrating a method 900 performed by a TUE belonging to an SPG administered by an AUE to request the AUE to change a type of SL-PRS being used by the SPG, according to an example implementation of the present disclosure (e.g., associated with the method 600 of FIG. 6 and the communication diagrams 700 and 800 of FIGS. 7 and 8, respectively). In the method 900, at operation 902, the TUE may send, to the AUE, a UEAssistanceInformationSidelink message. As indicated above, the UEAssistanceInformationSidelink message may indicate an optional SL-PRS (e.g., via a SidelinkPRS-Type-r18 IE and a corresponding supportedBandListSidelinkPRS-r18 IE, as discussed above) or the default SL-PRS (e.g., by including an empty SidelinkPRS-Type-r18 IE).

Thereafter, at operation 904, if the TUE receives the type of SL-PRS that was indicated by the TUE to the AUE in the UEAssistanceInformationSidelink message, method 900 may terminate. Otherwise (e.g., if the TUE continues to receive the current type of SL-PRS employed in the SPG), the TUE proceeds to operation 906, in which the TUE starts a Prohibit Timer. At operation 908, the TUE waits until the Prohibit Timer expires to transmit another UEAssistanceInformationSidelink message to request the same type of SL-PRS that the TUE previously requested. However, in some implementations, prior to the expiration of the Prohibit Timer, the TUE may request the AUE to change to a different type of SL-PRS for the SPG, or the TUE may request the AUE to change a type of SL-PRS for another SPG. Method 900 may then terminate.

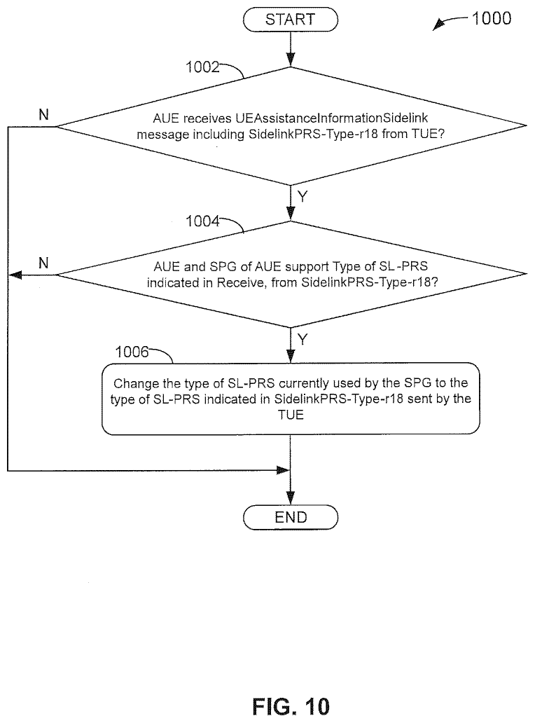

FIG. 10 is a flowchart illustrating a method 1000 performed by an AUE to change a type of SL-PRS used by an SPG administered by the AUE at the request of a TUE, according to an example implementation of the present disclosure (e.g., associated with the method 600 of FIG. 6 and the communication diagrams 700 and 800 of FIGS. 7 and 8, respectively). In the method 1000, at operation 1002, if the AUE does not receive a UEAssistanceInformationSidelink message, method 1000 may terminate. Otherwise, if the AUE receives a UEAssistanceInformationSidelink message, the AUE may proceed to operation 1004. In some implementations, as indicated above, the UEAssistanceInformationSidelink message may indicate an optional SL-PRS (e.g., via a SidelinkPRS-Type-r18 IE and a corresponding supportedBandListSidelinkPRS-r18 IE, as discussed above) or the default SL-PRS (e.g., by including an empty SidelinkPRSType-r18 IE).

At operation 1004, the AUE determines if the AUE and the SPG it administers support the type of SL-PRS requested by the TUE in the UEAssistanceInformationSidelink message. If not, method 1000 may terminate, thus allowing the AUE to continue to periodically transmit the type of SL-PRS currently being employed in the SPG. Otherwise, the AUE proceeds to operation 1006, in which the AUE changes the type of SL-PRS currently used by the SPG to the type of SL-PRS requested by the TUE in the UEAssistanceInformationSidelink message. The method 1000 may then terminate.

To operate in accordance with the implementations discussed above in conjunction with FIGS. 6-10, a communication system and its various components, in addition to those listed above with respect to FIGS. 2-5, may include the following:

An AUE of the system capable of obtaining assistance information from a device, where the assistance information of the device is obtained by the AUE via a sidelink message exchange between the AUE and the device via a PC5 interface. In some implementations, the assistance information exchange between the AUE and the device includes a type of SL-PRS supported by the device.

An AUE of the system capable of determining the suitability of the use of a type of SL-PRS by the AUE and the SPG administered by the AUE with the support and coordination of a gNB while in-coverage of the system and while not in-coverage of the system. In some implementations, the determination may take into account the SL-PRS resources available to the AUE and/or the types of SL-PRS supported by the AUE and the TUEs associated with the SPG.

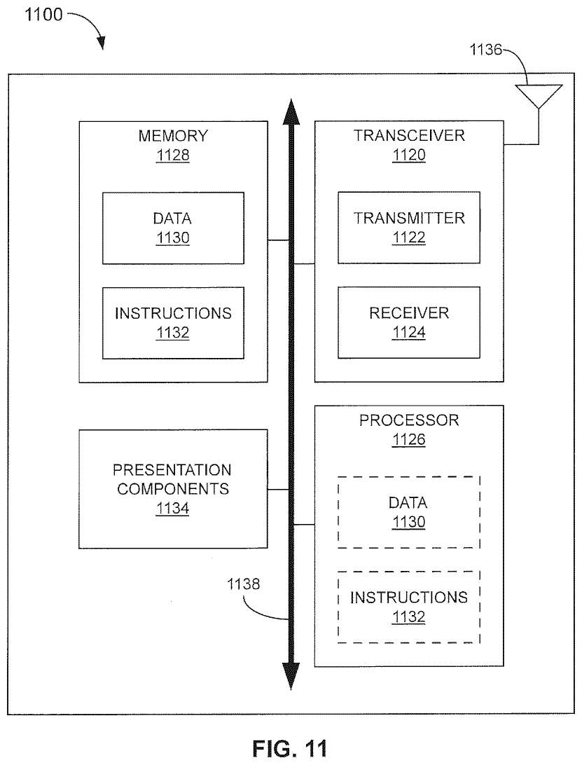

FIG. 11 illustrates a block diagram of a node for wireless communication, according to one example implementation of the present application. As shown in FIG. 11, node 1100 may include transceiver 1120, processor 1126, memory 1128, one or more presentation components 1134, and at least one antenna 1136. Node 1100 may also include a Radio Frequency (RF) spectrum band module, a base station communications module, a network communications module, and a system communications management module, input/output (I/O) ports, I/O components, and power supply (not explicitly shown in FIG. 11). Each of these components may be in communication with each other, directly or indirectly, over one or more buses 1140.

Transceiver 1120 having transmitter 1122 and receiver 1124 may be configured to transmit and/or receive time and/or frequency resource partitioning information. In some implementations, transceiver 1120 may be configured to transmit in different types of subframes and slots including, but not limited to, usable, non-usable, and flexibly usable subframes and slot formats. Transceiver 1120 may be configured to receive data and control signaling.

Node 1100 may include a variety of computer-readable media. Computer-readable media can be any available media that can be accessed by node 1100 and include both volatile and non-volatile media, removable and non-removable media. By way of example, and not limitation, computer-readable media may include computer storage media and communication media. Computer storage media may include both volatile and non-volatile, removable and non-removable media implemented in any method or technology for storage of information, such as computer-readable instructions, data structures, program modules, or other data.

Computer storage media include RAM, ROM, EEPROM, flash memory, or other memory technology, CD-ROM, digital versatile disks (DVD), or other optical disk storage, magnetic cassettes, magnetic tape, magnetic disk storage, or other magnetic storage devices. Computer storage media do not include a propagated data signal. Communication media typically embody computer-readable instructions, data structures, program modules, or other data in a modulated data signal, such as a carrier wave, or other transport mechanism and includes any information delivery media. The term “modulated data signal” means a signal that has one or more of its characteristics set or changed in such a manner as to encode information in the signal. By way of example, and not limitation, communication media include wired media, such as a wired network or direct-wired connection, and wireless media, such as acoustic, RF, infrared, and other wireless media. Combinations of any of the above should also be included within the scope of computer-readable media.

Memory 1128 may include computer-storage media in the form of volatile and/or non-volatile memory. Memory 1128 may be removable, non-removable, or a combination thereof. Exemplary memory includes solid-state memory, hard drives, optical-disc drives, etc. As illustrated in FIG. 11, memory 1128 may store computer-readable, computer-executable instructions 1132 (e.g., software codes) that are configured to, when executed, cause processor 1126 to perform various functions described herein, for example, with reference to FIGS. 1 through 11. Alternatively, instructions 1132 may not be directly executable by processor 1126 but be configured to cause node 1100 (e.g., when compiled and executed) to perform various functions described herein.

Processor 1126 may include an intelligent hardware device, for example, a central processing unit (CPU), a microcontroller, an ASIC, etc. Processor 1126 may include memory. Processor 1126 may process data 1130 and instructions 1132 received from memory 1128, and information through transceiver 1120, the baseband communications module, and/or the network communications module. Processor 1126 may also process information to be sent to transceiver 1120 for transmission through antenna 1136, to the network communications module for transmission to a core network.

One or more presentation components 1134 presents data indications to a person or other device. For example, one or more presentation components 1134 include a display device, speaker, printing component, vibrating component, etc.

From the above description, it is manifest that various techniques can be used for implementing the concepts described in the present application without departing from the scope of those concepts. Moreover, while the concepts have been described with specific reference to certain implementations, a person of ordinary skill in the art may recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

An example of a UECapabilityInformationSidelink message that carries new IEs sidelinkPRS-TypeList-r18, sidelinkPRS-TypeList-r18, and supportedBandListSidelinkPRS-r18 is illustrated in Table 3 below. In some implementations, the UECapability InformationSidelink message may be used to transfer UE radio access capabilities from one UE to another. In some implementations, the message may be applied to a unicast NR sidelink communication. Further, in some implementations, the Signaling Radio Bearer (SRB) may be SL-SRB3 and the Radio Link Control Service Access Point (RLC-SAP) may operate in Acknowledged Mode (AM).

TABLE 3
UECapabilityInformationSidelink Message

-- ASN1START
-- TAG-UECAPABILITYINFORMATIONSIDELINK-START

| | |
|---|---|
| UECapabilityInformationSidelink ::= | SEQUENCE { |
| rrc-TransactionIdentifier-r16 | RRC-TransactionIdentifier, |
| criticalExtensions | CHOICE { |
| ueCapabilityInformationSidelink-r16 | UECapabilityInformationSidelink- |

r16-IEs,

| | |
|---|---|
| criticalExtensionsFuture | SEQUENCE { } |

}
}

| | |
|---|---|
| UECapabilityInformationSidelink-r16-IEs ::= | SEQUENCE { |
| accessStratumReleaseSidelink-r16 | AccessStratumReleaseSidelink-r16, |
| pdcp-ParametersSidelink-r16 | PDCP-ParametersSidelink-r16 |

OPTIONAL,

| | |
|---|---|
| rlc-ParametersSidelink-r16 | RLC-ParametersSidelink-r16 |

OPTIONAL,

| | |
|---|---|
| supportedBandCombinationListSidelinkNR-r16 | BandCombinationListSidelinkNR-r16 |

OPTIONAL,

| | |
|---|---|
| supportedBandListSidelinkPRS-r18 | SEQUENCE (SIZE (1..maxBands)) OF |
| BandSidelinkPC5-r16 | OPTIONAL, |
| appliedFreqBandListFilter-r16 | FreqBandList |

OPTIONAL,

| | |
|---|---|
| lateNonCriticalExtension | OCTET STRING |

OPTIONAL,

| | |
|---|---|
| nonCriticalExtension | UECapabilityInformationSidelink-v1700- |
| IEs | OPTIONAL |

}
UECapabilityInformationSidelink-v1700-IEs ::= SEQUENCE {

| | |
|---|---|
| mac-ParametersSidelink-r17 | MAC-ParametersSidelink-r17 |

OPTIONAL,

| | |
|---|---|
| supportedBandCombinationListSidelinkNR-v1710 | BandCombinationListSidelinkNR-v1710 |

OPTIONAL,

| | |
|---|---|
| nonCriticalExtension | SEQUENCE { } |

OPTIONAL
}
UECapabilityInformationSidelink-v1800-IEs ::= SEQUENCE {

| | |
|---|---|
| sidelinkPRS-TypeList-r18 | SEQUENCE (SIZE (0..maxSL-PRS-Type)) OF |
| SidelinkPRS-Type-r18 | OPTIONAL, |
| maxSL-PRS-Type | INTEGER (8) |

OPTIONAL,

| | |
|---|---|
| nonCriticalExtension | SEQUENCE {} |

OPTIONAL
}
SidelinkPRS-Type-r18 ::= {
ENUMERATED { type1, type2, spare6, spare5, spare4, spare3, spare2, spare1, ...}

| | |
|---|---|
| supportedBandListSidelinkPRS-r18 | SEQUENCE (SIZE (1..maxBands)) OF |
| BandSidelinkPC5-r16 | OPTIONAL, |

```
}
      :
      The remainder removed for brevity
      :
-- TAG-UECAPABILITYINFORMATIONSIDELINK-STOP
-- ASN1STOP
Field Descriptions:
sidelinkPRS-TypeList-r18
This field may indicate the list of optional types of SL-PRS supported by the device.
SidelinkPRS-Type-r18
This field may configure the sidelinkPRS-TypeList-r18 with the optional types of SL-PRS supported by the device.
For example, type1 may be used to indicate an SL-PRS that uses a pseudo-random sequence that is modulated by
Quadrature Phase Shift Keying (QPSK). The pseudo-random sequence used may be a Gold sequence of length 31.
For example, type2 may be used to indicate an SL-PRS that uses an OFDM-modulated Zadoff-Chu sequence.
supportedBandListSidelinkPRS-r18
This field may indicate the UE-supported NR frequency bands.
```

An example of a UEAssistanceInformationSidelink message that carries new IEs SidelinkPRS-Type-r18 and supportedBandListSidelinkPRS-r18 is illustrated in Table 4 below. In some implementations, the UEAssistanceInformationSidelink message may include Discontinuous Reception (DRX) used to determine a sidelink DRX configuration. In some implementations, the UEAssistanceInformationSidelink message may be transmitted from one UE to another. Further, in some implementations, the SRB may be SL-SRB3 and the RLC-SAP may operate in Acknowledged Mode (AM).

TABLE 4
UEAssistanceInformationSidelink Message

-- ASN1START
-- TAG-UEASSISTANCEINFORMATIONSIDELINK-START

| | |
|---|---|
| UEAssistanceInformationSidelink -r17 ::= | SEQUENCE { |
| criticalExtensions | CHOICE { |
| ueAssistanceInformationSidelink-r17 | UEAssistanceInformationSidelink |

-r17-IEs,

| | |
|---|---|
| criticalExtensionsFuture | SEQUENCE { } |

}
}

| | |
|---|---|
| UEAssistanceInformationSidelink -r17-IEs ::= | SEQUENCE { |
| sl-PreferredDRX-ConfigList-r17 | SEQUENCE (SIZE (1..maxNrofSL-RxInfoSet-r17)) OF |

SL-DRX-ConfigUC-SemiStatic-r17
OPTIONAL, -- Need R

| | |
|---|---|
| lateNonCriticalExtension | OCTET STRING |

OPTIONAL,

| | |
|---|---|
| nonCriticalExtension | SEQUENCE { } |

OPTIONAL
}
SidelinkPRS-Type-r18 ::= {
ENUMERATED { type1, type2, spare6, spare5, spare4, spare3, spare2, spare1, ...}

| | |
|---|---|
| supportedBandListSidelink-r18 | SEQUENCE (SIZE (1..maxBands)) OF BandSidelinkPC5- |
| r16 | OPTIONAL, |

}
-- TAG-UEASSISTANCEINFORMATIONSIDELINK-STOP
-- ASN1STOP
Field Description:
SidelinkPRS-Type-r18
This field may configure the sidelinkPRS-TypeList-r18 with the optional types of SL-PRS supported by the device.
For example, type1 may be used to indicate an SL-PRS that uses a pseudo-random sequence that is modulated by
Quadrature Phase Shift Keying (QPSK). The pseudo-random sequence used may be a Gold sequence of length 31.
For example, type2 may be used to indicate an SL-PRS that uses an OFDM-modulated Zadoff-Chu sequence.
supportedBandListSidelinkPRS-r18
This field may indicate the UE-supported NR frequency bands.

The following Table 5 illustrates an example of what an NR UE may do upon reception of an SCCH-Message with a UECapabilityInformationSidelink message that includes a sidelinkPRS-TypeList-r18 IE, as an addition to the existing text in TS 38.331.

TABLE 5
5.8.9.2.4 Actions related to reception of the
UECapabilityInformationSidelink by the UE:

1> if sidelinkPRS-TypeList-r18 is included:
2> submit sidelinkPRS-TypeList-r18 to higher layer
.... Remaining text of 5.8.9.2.4 removed for brevity....

The following Table 6 illustrates an example of what an NR UE may do upon reception of an SCCH-Message with a UEAssistanceInformationSidelink message that includes a SidelinkPRS-Type-r18 IE, as an addition to the existing text in TS 38.331.

TABLE 6
5.8.9.6.3 Actions related to reception of the
UEAssistanceInformationSidelink by the UE:

For sidelink unicast, when a UE is in RRC_CONNECTED state and is
performing sidelink operation and has obtained the
SidelinkPRS-Type-r18 IE from the UEAssistanceInformationSidelink
message transmitted from a peer UE, the UE may determine the type of
SL-PRS configuration to be transmitted by the AUE for the use of the
SPG associated with the peer UE as requested by the peer UE.

In one example, a terminal device for requesting a change in a type of Sidelink Positioning Reference Signal (SL-PRS) for a Sidelink Positioning Group (SPG) in a New Radio (NR) system, the terminal device comprising: one or more non-transitory computer-readable media storing a set of computer-executable instructions; and at least one processor coupled to the one or more non-transitory computer-readable media and configured to execute the set of computer-executable instructions to cause the terminal device to perform operations comprising: receiving, as a target terminal device associated with the SPG, from an anchor terminal device of the SPG, a first type of SL-PRS for the SPG; transmitting, to the anchor terminal device, a first message comprising a request to change to a second type of SL-PRS for the SPG, the second type of SL-PRS being different from the first type of SL-PRS; and receiving, from the anchor terminal device, in response to the anchor terminal device determining that the second type of SL-PRS is supported in the SPG, the second type of SL-PRS for the SPG.

In one example, the terminal device, the operations further comprising: receiving, from the anchor terminal device, in response to the anchor terminal device determining that the second type of SL-PRS is not supported in the SPG, the first type of SL-PRS for the SPG.

In one example, the terminal device, the operations further comprising: starting a timer in response to receiving the first type of SL-PRS after transmitting the first message, wherein the terminal device is prohibited from transmitting, to the anchor terminal device, a second message including the request to change to the second type of SL-PRS for the SPG prior to an expiration of the timer.

In one example, the terminal device, wherein: the terminal device is not prohibited from transmitting, to the anchor terminal device, a third message including a request to change to a third type of SL-PRS for the SPG prior to the expiration of the timer, and the third type of SL-PRS is different from the second type of SL-PRS.

In one example, the terminal device, wherein: the first message comprises a UEAssistanceInformationSidelink message.

In one example, the terminal device, wherein: the second type of SL-PRS is a default type of SL-PRS when the UEAssistanceInformationSidelink message includes a first information element (IE) that is empty.

In one example, the terminal device, wherein: the first IE comprises a SidelinkPRSType-r18 IE.

In one example, the terminal device, wherein: the second type of SL-PRS is an optional type of SL-PRS when the UEAssistanceInformationSidelink message includes a first information element (IE) indicating the optional type of SL-PRS.

In one example, the terminal device, wherein: the first IE comprises a SidelinkPRS-Type-r18 IE.

In one example, the terminal device, wherein: the UEAssistanceInformationSidelink message further includes a second IE indicating one or more frequency bands supported by the optional type of SL-PRS when the UEAssistanceInformationSidelink message includes the first IE.

In one example, the terminal device, wherein: the second IE comprises a supportedBandListSidelinkPRS-r18 IE.

In one example, a method performed by a terminal device to request a change in a type of Sidelink Positioning Reference Signal (SL-PRS) for a Sidelink Positioning Group (SPG) in a New Radio (NR) system, the method comprising: receiving, as a target terminal device associated with the SPG, from an anchor terminal device of the SPG, a first type of SL-PRS for the SPG; transmitting, to the anchor terminal device, a first message comprising a request to change to a second type of SL-PRS for the SPG, the second type of SL-PRS being different from the first type of SL-PRS; and receiving, from the anchor terminal device, in response to the anchor terminal device determining that the second type of SL-PRS is supported in the SPG, the second type of SL-PRS for the SPG.

In one example, the method, further comprising: receiving, from the anchor terminal device, in response to the anchor terminal device determining that the second type of SL-PRS is not supported in the SPG, the first type of SL-PRS for the SPG.

In one example, the method, further comprising: starting a timer in response to receiving the first type of SL-PRS after transmitting the first message, wherein the terminal device is prohibited from transmitting, to the anchor terminal device, a second message including the request to change to the second type of SL-PRS for the SPG prior to an expiration of the timer.

In one example, the method, wherein: the terminal device is not prohibited from transmitting, to the anchor terminal device, a third message including a request to change to a third type of SL-PRS for the SPG prior to the expiration of the timer, and the third type of SL-PRS is different from the second type of SL-PRS.

In one example, the method, wherein: the first message comprises a UEAssistanceInformationSidelink message.

In one example, the method, wherein: the second type of SL-PRS is a default type of SL-PRS when the UEAssistanceInformationSidelink message includes a first information element (IE) that is empty.

In one example, the method, wherein: the first IE comprises a SidelinkPRS-Type-r18 IE.

In one example, the method, wherein: the second type of SL-PRS is an optional type of SL-PRS when the UEAssistanceInformationSidelink message includes a first information element (IE) indicating the optional type of SL-PRS.

In one example, the method, wherein: the first IE comprises a SidelinkPRS-Type-r18 IE.

In one example, the method, wherein: the UEAssistanceInformationSidelink message further includes a second IE indicating one or more frequency bands supported by the optional type of SL-PRS when the UEAssistanceInformationSidelink message includes the first IE.

In one example, the method, wherein: the second IE comprises a supportedBandListSidelinkPRS-r18 IE.

In one example, a terminal device for receiving a request to change a type of Sidelink Positioning Reference Signal (SL-PRS) for a Sidelink Positioning Group (SPG) administered by the terminal device in a New Radio (NR) system, the terminal device comprising: one or more non-transitory computer-readable media storing a set of computer-executable instructions; and at least one processor coupled to the one or more non-transitory computer-readable media and configured to execute the set of computer-executable instructions to cause the terminal device to perform operations comprising: transmitting, to a target terminal device associated with the SPG, a first type of SL-PRS for the SPG; receiving, from the target terminal device, a first message comprising a request to change to a second type of SL-PRS for the SPG, the second type of SL-PRS being different from the first type of SL-PRS; determining whether the second type of SL-PRS is supported in the SPG; and transmitting, to the target terminal device, after determining that the second type of SL-PRS is supported in the SPG, the second type of SL-PRS for the SPG.

In one example, the terminal device, the operations further comprising: transmitting, to the target terminal device, after determining that the second type of SL-PRS is not supported in the SPG, the first type of SL-PRS for the SPG.

In one example, the terminal device, wherein determining whether the second type of SL-PRS is supported in the SPG comprises: determining whether the terminal device and every target terminal device of the SPG supports the second type of SL-PRS.

In one example, the terminal device, wherein determining whether the second type of SL-PRS is supported in the SPG further comprises: determining whether the terminal device and every target terminal device of the SPG supports all frequency bands supported by the second type of SL-PRS.

In one example, the terminal device, wherein: the first message comprises a UEAssistanceInformationSidelink message.

In one example, the terminal device, wherein: the second type of SL-PRS is a default type of SL-PRS when the UEAssistanceInformationSidelink message includes a first information element (IE) that is empty.

In one example, the terminal device, wherein: the first IE comprises a SidelinkPRSType-r18 IE.

In one example, the terminal device, wherein: the second type of SL-PRS is an optional type of SL-PRS when the UEAssistanceInformationSidelink message includes a first information element (IE) indicating the optional type of SL-PRS.

In one example, the terminal device, wherein: the first IE comprises a SidelinkPRSType-r18 IE.

In one example, the terminal device, wherein: the UEAssistanceInformationSidelink message further includes a second IE indicating one or more frequency bands supported by the optional type of SL-PRS when the UEAssistanceInformationSidelink message includes the first IE.

In one example, the terminal device, wherein: the second IE comprises a supportedBandListSidelinkPRS-r18 IE.

In one example, a method for a terminal device to receive a request to change a type of Sidelink Positioning Reference Signal (SL-PRS) for a Sidelink Positioning Group (SPG) administered by the terminal device in a New Radio (NR) system, the method comprising: transmitting, to a target terminal device associated with the SPG, a first type of SL-PRS for the SPG; receiving, from the target terminal device, a first message comprising a request to change to a second type of SL-PRS for the SPG, the second type of SL-PRS being different from the first type of SL-PRS; determining whether the second type of SL-PRS is supported in the SPG; and transmitting, to the target terminal device, after determining that the second type of SL-PRS is supported in the SPG, the second type of SL-PRS for the SPG.

In one example, the method, further comprising: transmitting, to the target terminal device, after determining that the second type of SL-PRS is not supported in the SPG, the first type of SL-PRS for the SPG.

In one example, the method, wherein determining whether the second type of SL-PRS is supported in the SPG comprises: determining whether the terminal device and every target terminal device of the SPG supports the second type of SL-PRS.

In one example, the method, wherein determining whether the second type of SL-PRS is supported in the SPG further comprises: determining whether the terminal device and every target terminal device of the SPG supports all frequency bands supported by the second type of SL-PRS.

In one example, the method, wherein: the first message comprises a UEAssistanceInformationSidelink message.

In one example, the method, wherein: the second type of SL-PRS is a default type of SL-PRS when the UEAssistanceInformationSidelink message includes a first information element (IE) that is empty.

In one example, the method, wherein: the first IE comprises a SidelinkPRS-Type-r18 IE.

In one example, the method, wherein: the second type of SL-PRS is an optional type of SL-PRS when the UEAssistanceInformationSidelink message includes a first information element (IE) indicating the optional type of SL-PRS.

In one example, the method, wherein: the first IE comprises a SidelinkPRS-Type-r18 IE.

In one example, the method, wherein: the UEAssistanceInformationSidelink message further includes a second IE indicating one or more frequency bands supported by the optional type of SL-PRS when the UEAssistanceInformationSidelink message includes the first IE.

In one example, the method, wherein: the second IE comprises a supportedBandListSidelinkPRS-r18 IE.

1. A terminal device for requesting a change in a type of Sidelink Positioning Reference Signal (SL-PRS) for a Sidelink Positioning Group (SPG) in a New Radio (NR) system, the terminal device comprising:
one or more non-transitory computer-readable media storing a set of computer-executable instructions; and
at least one processor coupled to the one or more non-transitory computer-readable media and configured to execute the set of computer-executable instructions to cause the terminal device to perform operations comprising:
receiving, as a target terminal device associated with the SPG, from an anchor terminal device of the SPG, a first type of SL-PRS for the SPG;
transmitting, to the anchor terminal device, a first message comprising a request to change to a second type of SL-PRS for the SPG, the second type of SL-PRS being different from the first type of SL-PRS; and
receiving, from the anchor terminal device, in response to the anchor terminal device determining that the second type of SL-PRS is supported in the SPG, the second type of SL-PRS for the SPG.

2. The terminal device of claim 1, the operations further comprising: receiving, from the anchor terminal device, in response to the anchor terminal device determining that the second type of SL-PRS is not supported in the SPG, the first type of SL-PRS for the SPG.

3. The terminal device of claim 2, the operations further comprising: starting a timer in response to receiving the first type of SL-PRS after transmitting the first message,
wherein the terminal device is prohibited from transmitting, to the anchor terminal device, a second message including the request to change to the second type of SL-PRS for the SPG prior to an expiration of the timer.

4. The terminal device of claim 3, wherein:
the terminal device is not prohibited from transmitting, to the anchor terminal device, a third message including a request to change to a third type of SL-PRS for the SPG prior to the expiration of the timer, and the third type of SL-PRS is different from the second type of SL-PRS.

5. The terminal device of claim 1, wherein:
the first message comprises a UEAssistanceInformationSidelink message.

6. The terminal device of claim 5, wherein:
the second type of SL-PRS is a default type of SL-PRS when the UEAssistanceInformationSidelink message includes a first information element (IE) that is empty.

7. The terminal device of claim 6, wherein:
the first IE comprises a SidelinkPRS-Type-r18 IE.

8. The terminal device of claim 5, wherein:
the second type of SL-PRS is an optional type of SL-PRS when the UEAssistanceInformationSidelink message includes a first information element (IE) indicating the optional type of SL-PRS.

9. The terminal device of claim 8, wherein:
the first IE comprises a SidelinkPRS-Type-r18 IE.

10. The terminal device of claim 8, wherein:
the UEAssistanceInformationSidelink message further includes a second IE indicating one or more frequency bands supported by the optional type of SL-PRS when the UEAssistanceInformationSidelink message includes the first IE.

11. The terminal device of claim 10, wherein:
the second IE comprises a supportedBandListSidelinkPRS-r18 IE.

12. A terminal device for receiving a request to change a type of Sidelink Positioning Reference Signal (SL-PRS) for a Sidelink Positioning Group (SPG) administered by the terminal device in a New Radio (NR) system, the terminal device comprising:
one or more non-transitory computer-readable media storing a set of computer-executable instructions; and
at least one processor coupled to the one or more non-transitory computer-readable media and configured to execute the set of computer-executable instructions to cause the terminal device to perform operations comprising:
transmitting, to a target terminal device associated with the SPG, a first type of SL-PRS for the SPG;
receiving, from the target terminal device, a first message comprising a request to change to a second type of SL-PRS for the SPG, the second type of SL-PRS being different from the first type of SL-PRS;
determining whether the second type of SL-PRS is supported in the SPG; and
transmitting, to the target terminal device, after determining that the second type of SL-PRS is supported in the SPG, the second type of SL-PRS for the SPG.

13. The terminal device of claim 12, the operations further comprising:
transmitting, to the target terminal device, after determining that the second type of SL-PRS is not supported in the SPG, the first type of SL-PRS for the SPG.

14. The terminal device of claim 12, wherein determining whether the second type of SL-PRS is supported in the SPG comprises:
determining whether the terminal device and every target terminal device of the SPG supports the second type of SL-PRS.

15. The terminal device of claim 14, wherein determining whether the second type of SL-PRS is supported in the SPG further comprises:
determining whether the terminal device and every target terminal device of the SPG supports all frequency bands supported by the second type of SL-PRS.
